(19) United States
(12) Patent Application Publication
(10) Pub. No.: US 2024/0048486 A1
(43) Pub. Date: Feb. 8, 2024

(54) ROUTING DATA IN AN INTEGRATED ACCESS AND BACKHAUL NETWORK

(71) Applicant: CANON KABUSHIKI KAISHA, Tokyo (JP)

(72) Inventors: Pascal LAGRANGE, LA CHAPELLE DES FOUGERETZ (FR); Pierre VISA, RENNES (FR)

(21) Appl. No.: 18/555,207

(22) PCT Filed: Apr. 14, 2022
(86) PCT No.: PCT/EP2022/060094

§ 371 Date: Oct. 12, 2023

(30) Foreign Application Priority Data
Apr. 15, 2021 (GB) 2105414.3
May 12, 2021 (GB) 2106779.8

(51) Int. Cl. H04L 45/745; H04W 28/02; H04W 40/02

(52) U.S. Cl. CPC H04L 45/745; H04W 28/0236; H04W 40/02

(57) ABSTRACT

A method for processing data packets at an integrated access and backhaul, IAB, node of an IAB network comprising a plurality of IAB nodes is disclosed. The method comprises receiving a data packet including a destination address of a destination IAB node for the data packet and a path identifier identifying a routing path for the data packet to the destination IAB node; determining, based on the received data packet, whether the routing path of the received data packet includes at least one IAB node of a different IAB network; in response to determining that the routing path of the received data packet includes at least one IAB node of a different IAB network, using the path identifier of the received data packet to determine whether there is a next IAB node in the routing path for routing the data packet. When a next IAB node is determined, the data packet is routed to the next IAB node.

### FIELD OF THE INVENTION

The present invention generally relates to routing data and managing routing of data in an integrated access and backhaul, IAB, network of a wireless communication system.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems-based IEEE 802.11 standards, such as WiFi.

The demand for network densification (e.g. denser placement of base stations) increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications or links (between base stations) may use the same radio resources as access communications or links (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

However, millimeter waves are known to be subject to strong attenuations of signal strength in some weather conditions (rain, fog), and to blockage in case of obstacles located in the path between the emitter and the receiver.

To cope with these potential radio link failures, a topological redundancy can be provided within the IAB framework, where multiple backhaul paths are set up between the IAB base station directly connected to the core network (also referred to as the “IAB-donor”) and the IAB base station serving a UE (also referred to as the “access IAB-node” for the UE). Several intermediate IAB base stations (also referred to as IAB-nodes) may be involved in each of the several backhaul paths between the IAB-donor and the access IAB-node, thus forming alternative data paths within a multi-hop IAB network.

A path through a set of IAB-nodes is defined by default along which the data are preferably transmitted. Also, one or more back-up paths along different sets of IAB-nodes are defined that can be used in case a radio link failure (RLF) occurs on any link of the default path. A link is defined between two successive IAB-nodes in the backhaul network. A back-up path is also useful in case of congestion of a link due to an excessive demand of application traffic compared to the default link capacity. Traffic re-routing to a back-up path or load balancing between the default path and one or more back-up paths may be activated to mitigate the congestion.

In the IAB-network topology, the direction from the IAB-donor toward the access IAB-nodes (and thus the UEs) is referred to as downstream, hence defining a parent IAB-node and a child IAB-node for each link. The direction toward the IAB-donor is referred to as upstream. Each IAB-node coupled directly or indirectly to the IAB-donor comprises an IAB-MT (IAB-Mobile Termination) to communicate in the upstream direction and an IAB-DU (IAB-Distributed Unit) to communicate in the downstream direction.

Like a legacy 5G base station (gNB), the IAB-donor consists of a central unit (CU or gNB-CU functionality) and of one or more distributed unit(s) (DU or gNB-DU functionality). The IAB-donor-CU hosts higher layer protocols for controlling operation of one or more DUs and each of the one or more IAB-donor-DUs include lower layer protocols including the Physical layer and Radio Frequency part. The IAB-donor-CU and the one or more IAB-donor-DUs may be located far from each other. Then a wired IP network (typically with fiber connections) exists to interconnect these different devices. The interest of having several DUs connected to a single CU is the centralization and the resource sharing of less time-critical operations in the CU (virtualization), while time-critical operations like scheduling, fast retransmission, segmentation, etc. . . . are performed in the DUs. As a consequence, in the downstream direction, there may be several backhaul paths from the IAB-donor-CU to an IAB-node through different IAB-donor-DUs. Similarly in upstream direction, there may be several possible backhaul paths from the source IAB-node to reach the IAB-donor-CU through different IAB-donor-DUs.

To enable routing over multiple backhaul hops, a specific IAB protocol sublayer was introduced, the backhaul adaptation protocol (BAP) sublayer, which is specified in the 3GPP release-16 specifications TS 38.340 (version 16.3.0). There is one BAP entity in an IAB-MT, one BAP entity in an IAB-DU, and one BAP entity in an IAB-donor-DU. A unique BAP address is assigned to each IAB-node and to each IAB-donor-DU by the IAB-donor CU in charge of managing the IAB network. The BAP sublayer encapsulates IP SDUs (Service Data Units) into BAP PDUs (Protocol Data Units), where each BAP PDU consists of a BAP header and a payload section, which includes the IP SDUs.

The BAP header includes a BAP Routing ID, which is the concatenation of the destination BAP address and the identifier of the backhaul path to follow (Path ID). The BAP routing ID is set by the BAP sublayer of the initiator IAB-donor-DU (in the downstream direction) or the initiator IAB-node (in the upstream direction). Then, BAP PDUs are routed according to the BAP Routing ID using a backhaul routing table configured by the IAB-donor-CU in each IAB-node and in each IAB-donor-DU. Upon reception of a BAP PDU in a BAP entity, the destination BAP address is compared to the local BAP address. If the local address matches the destination BAP address, the BAP header is removed and the payload is delivered to the upper layers.

For a BAP entity in an IAB-donor-DU, if the destination BAP address does not match the local BAP address, the BAP PDU is discarded. For a BAP entity in the IAB-MT or the IAB-DU of an IAB-node, if the destination BAP address does not match the local BAP address, the BAP PDU is delivered to the collocated BAP entity for routing and transmission to the next hop. The backhaul routing table provides the egress link corresponding to the next hop BAP address, using the BAP routing ID in the BAP PDU header as the entry of the table. In case the indicated egress link is not available, for instance due to radio link failure (RLF), an entry with the same destination BAP address is selected regardless of the Path ID. The BAP PDU is discarded if no entry in the routing table matches the BAP Routing ID or the destination BAP address of the BAP header.

Recently, 3GPP has been considering inter-donor redundancy, where an IAB-node, referred to as a Boundary IAB node, can access two different parent nodes connected to two different IAB-donor CUs. The Boundary IAB-node, even though belonging to a single IAB network, i.e. belonging to a single IAB-donor CU for configuration and management, is thus able to route BAP PDUs from a first IAB network managed by a first IAB-donor CU to a second IAB network managed by a second IAB-donor CU. The advantage of such inter-donor redundancy lies in the ability for the first IAB-donor-CU to perform offloading by routing some of its BAP PDUs through the second IAB network, thus mitigating congestion issues or overcoming radio link failure issues that may arise in the first IAB network.

However, since the assignment of BAP addresses, BAP path IDs and Backhaul Radio Link Control Channel Identifiers (BH RLC CH IDs) is performed independently in each IAB network, the same values may be assigned in each topology, e.g. an IAB-node belonging to the first IAB network may be assigned the same address as an IAB-node belonging to the second IAB network, which may lead to significant routing issues. For instance, if a Boundary IAB-node of a first IAB network has the same address as an IAB-node in the second IAB network, when the Boundary IAB-node receives a BAP PDU with a header that includes a destination BAP address that matches the address of the Boundary IAB-node (and hence the address of the IAB-node in the second IAB network), the Boundary node will not be able to decide whether the BAP PDU is for the Boundary IAB-node and so has to be forwarded to upper layers or is intended for the IAB-node in the second IAB network and so has to forwarded to the next hop. Similarly, an IAB-node may re-route a BAP PDU to the wrong destination IAB-node.

Therefore, some new mechanisms are required to overcome the aforementioned issue, while limiting the complexity of the processing at an IAB-node as well as the latency that would result from such processing.

### SUMMARY

In accordance with a first aspect of the present invention, there is provided a method for processing data packets at an integrated access and backhaul, IAB, node of an IAB network comprising a plurality of IAB nodes, the method comprising:
receiving a data packet including a destination address of a destination IAB node for the data packet and a path identifier identifying a routing path for the data packet to the destination IAB node;
determining, based on the received data packet, whether the routing path of the received data packet includes at least one IAB node of a different IAB network;
in response to determining that the routing path of the received data packet includes at least one IAB node of a different IAB network, using the path identifier of the received data packet to determine whether there is a next IAB node in the routing path for routing the data packet,
when a next IAB node is determined, routing the data packet to the next IAB node.

In an example, in response to determining that the routing path of the received data packet includes at least one IAB node of a different IAB network, the IAB node uses the path identifier of the received data packet, and does not use the destination address of the received data packet, to determine whether there is a next IAB node in the routing path or to determine the next IAB node.

In an example, the IAB node may only use the path identifier to determine the next IAB node.

In an example, the method may further comprise receiving configuration information including a routing configuration table, each entry of the routing configuration table having a destination address field for an address of an IAB node and a path identifier field for a path identifier of a routing path to the IAB node. In this case, determining whether there is a next IAB node for routing the data packet using the path identifier of the received data packet may comprise comparing the path identifier of the received data packet with the path identifier field of the routing configuration table and when the path identifier of the received data packet matches a path identifier in the path identifier field, determining there is a next IAB node. When the path identifier of the received data packet does not match a path identifier in the path identifier field, determining there is not a next IAB node. In this case, the method may further comprise comparing the destination address of the received data packet with an address assigned to the IAB node, and when the destination address of the received data packet matches the address assigned to the IAB node, determining the IAB node is the destination IAB node.

In an example, the method may further comprise receiving configuration information including a routing configuration table, each entry of the routing configuration table having a destination address field for an address of an IAB node and a path identifier field for a path identifier of a routing path to the IAB node. In this case, determining whether there is a next IAB node for routing the data packet using the path identifier of the received data packet comprises comparing the path identifier of the received data packet with the path identifier field of the routing configuration table, and when the path identifier of the received data packet matches a path identifier in the path identifier field of an entry in the routing configuration table and when an address assigned to the IAB node does not match the address of the IAB node in the destination address field of the entry, determining there is a next IAB node. When the path identifier of the received data packet matches a path identifier in the path identifier field of an entry in the routing configuration table and when the destination address of the received data packet matches the address of the IAB node and the address in the destination address field of the entry, determining there is not a next IAB node and the IAB node is the destination IAB node.

The IAB node may be capable of routing data packets to one or more IAB nodes in the IAB network of the IAB node and to one or more IAB nodes in at least one different IAB network.

The IAB node may be assigned a first unique address for use by the IAB network of the IAB node and a second unique address for use by the at least one different IAB network.

The method may further comprise sending a notification to a donor Central Unit, CU, of the IAB network, indicating the IAB node is capable of routing data packets to one or more IAB nodes in the at least one different IAB network.

In accordance with a second aspect, there is provided a method for managing processing of data packets in a first integrated access and backhaul, IAB, network as recited in any one of claims 20 to 28 of the accompanying claims.

In accordance with a third aspect, there is provided an Integrated access and backhaul, IAB, node, as recited in claim 29.

In accordance with a fourth aspect, there is provided a donor Central Unit, CU, as recited in claim 30.

The present invention provides routing of data packets (such as backhaul adaptation protocol (BAP) protocol data units (PDUs)) over one or more integrated access backhaul (IAB) networks and thus, allows for the re-routing of data packets from a first IAB network to a second (e.g. a transit IAB network) IAB network.

By determining whether the routing path of data packet is a transit routing path or transit path through at least two IAB networks (for example, using the path identifier) and then after determining the routing path is a transit routing path through at least two IAB networks, using the path identifier (e.g. using the path identifier and not the destination address of the data packet routing ID) to route the data packet (e.g. to determine the next node in the transit routing path), alternate routing paths over a plurality of IAB networks can be used and issues with duplicate addresses, path identifiers, etc. due to the independent assignment in each of the IAB networks can be avoided. Also the complexity of the processing at an IAB-node is reduced compared to having to update the destination address and path identifier (e.g. BAP routing ID in the header) of the data packet as well as the latency that would result from such processing.

As discussed above, local re-routing of packets on an alternative path which includes at least one IAB node in one different IAB network (e.g. a neighbouring or transit IAB network) reduces service interruption time caused by backhaul Radio Link Failure (BH RLF) and can also facilitate load balancing between several paths to limit the risk of link congestion.

The data packets may be Backhaul Adaptation Protocol (BAP) packets or BAP Packet Data Units (PDUs). For BAP packets, the routing configuration table is a BAP routing configuration table where the destination address field and the path identifier field are part of a BAP routing ID. In such a case, the BAP routing ID comprises the BAP destination address field for the BAP address of an IAB node and path identifier field for identifying the path or routing path to the IAB node. A BAP packet includes a BAP header which includes a BAP routing ID for routing the BAP packet. The BAP routing ID of the BAP header includes a destination address field for the BAP address of an IAB node which corresponds to the destination IAB node of the BAP packet and path identifier field for identifying the path or routing path to the destination IAB node. The destination IAB node may be a donor DU for routing in the upstream direction or an IAB node in the downstream direction or may be an intermediate IAB node.

Further features of the invention are characterised by the other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with another aspect of the invention, there is provided a computer readable storage medium storing at least one computer program comprising instructions that, when executed by a processing unit, causes the processing unit to perform the method according to any aspect or example described above.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrating a wireless communication system including a wireless Integrated Access and Backhaul (IAB) network;

FIGS. 2a and 2b are schematic diagrams illustrating stacks of some protocol layers involved in IAB operations;

FIG. 3 is a schematic diagram illustrating the format of a BAP Protocol Data Unit (PDU) or packet;

FIG. 4 is a schematic diagram illustrating the routing management in an IAB network;

FIG. 5 illustrates fields of routing tables in IAB-nodes according to 3GPP TS 38.300;

FIG. 6 is a schematic diagram illustrating an example topology of an IAB network arrangement in which the present invention may be implemented according to one or more exemplary embodiments;

FIG. 7 illustrates fields of an example of configuration table at an IAB-node according to embodiments of the invention;

FIG. 8 illustrates, using a flowchart, a first exemplary method for managing BAP PDU routing over a plurality of IAB networks according to embodiments of the invention;

FIG. 9 illustrates, using a flowchart, a second exemplary method for managing BAP PDU routing over a plurality of IAB networks according to embodiments of the invention;

FIG. 10 is a schematic and simplified diagram illustrating an exemplary message flow for managing BAP PDU routing over a plurality of IAB networks according to embodiments of the invention;

FIG. 11 is a block schematic diagram of an example wireless communication device for implementing embodiments of the present invention;

FIG. 12 illustrates fields of an entry for a routing configuration table in IAB nodes according to embodiments of the invention.

FIG. 13 illustrates, using a flowchart, an exemplary method, at an IAB node, for processing data packets according to embodiments of the invention;

FIG. 14 illustrates, using a flowchart, an exemplary method, at a donor CU, for managing processing of data packets in an IAB according to embodiments of the invention;

FIG. 15 is a schematic and simplified diagram illustrating an exemplary message flow for managing BAP PDU routing over a plurality of IAB networks according to embodiments of the invention;

FIG. 16 is a schematic diagram illustrating an example format of a BAP Protocol Data Unit (PDU) or data packet according to embodiments of the invention;

FIG. 17 is a schematic and simplified diagram illustrating routing of data packets over two IAB networks according to embodiments of the invention; and

FIG. 18 is a schematic and simplified diagram illustrating routing of data packets over two IAB networks according to embodiments of the invention.

### DETAILED DESCRIPTION OF THE DRAWINGS

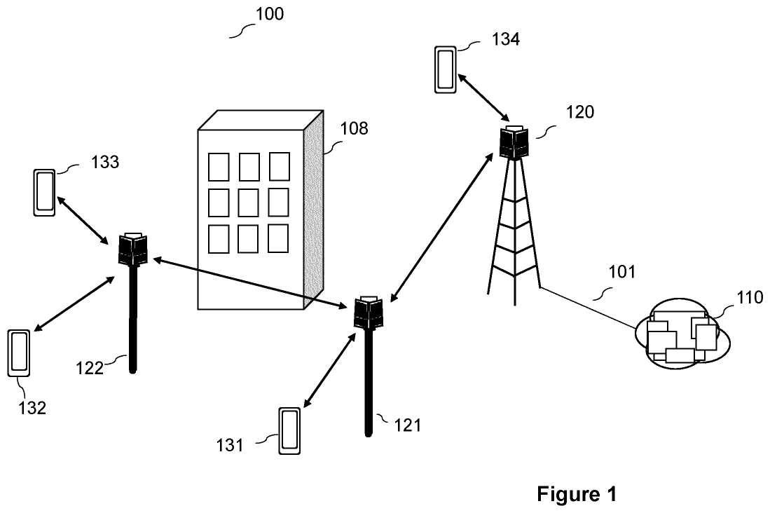

FIG. 1 illustrates an exemplary wireless communication system 100, in particular a mobile radio communication system such as a fifth-generation (5G) New Radio (NR) system including a wireless Integrated Access and Backhaul network. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul network which shares radio resources for wireless access links and wireless backhaul links.

The system 100 comprises a plurality of UEs (User Equipment) 132, 133, 131 and 134, a remote core network 110, a main Base Station 120, and two Integrated Access and Backhaul (IAB) stations or IAB nodes 121 and 122 (also referred to in the following as IAB-nodes).

The main Base Station 120, also referred to as the IAB-donor 120, is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 v16.2.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The IAB-donor 120 and the IAB-stations 121 and 122 are thus forming a backhaul network or IAB network, which accommodates UEs 132, 133, 131 and 134.

The specification of the Integrated Access and Backhaul (IAB) is spread over several 3GPP standard documents, including:
TS 38.300 RAN architecture (V16.2.0),
TS 38.321 MAC protocol (V16.1.0),
TS 38.331 Radio Resource Control (RRC) protocol (V16.1.0),
TS 38.340 Backhaul Adaptation Protocol Layer (V16.1.0),
TS 38.401 RAN architecture (V16.2.0),
TS 38.473 F1 Application Protocol (V16.2.0).

As IAB-nodes 121 and 122 are respectively connected to UEs 131, 132 and 133, they are considered as Access IAB-nodes for their respectively connected UEs.

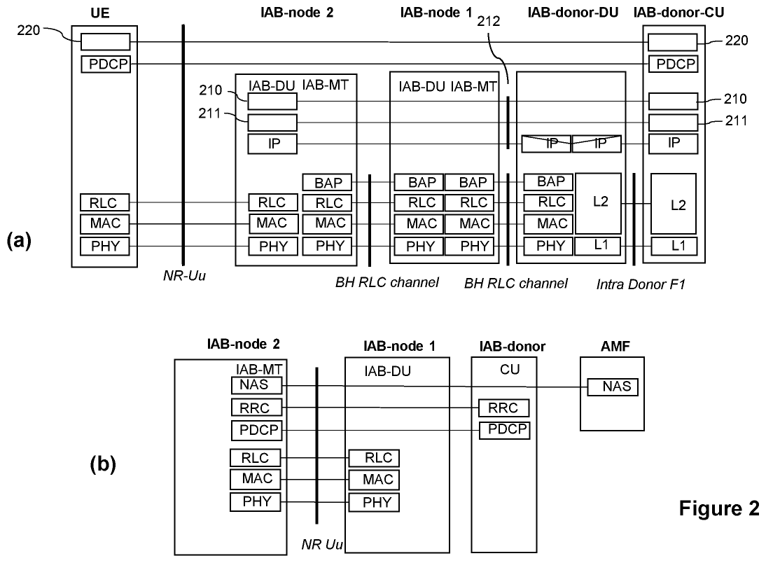

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU (also referred to in the following as IAB-donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU) includes lower layer protocols, such as the RLC, MAC and physical layer protocols. The IAB-donor CU or donor CU and IAB-donor DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes, which may serve multiple radio sectors, are wireless backhauled to the IAB-donor 120, via one or multiple hops over intermediate IAB nodes. They form a directed acyclic graph (DAG) topology with the IAB-donor at its root.

The IAB nodes consist of an IAB-DU and an IAB-MT (IAB-Mobile Termination). The gNB-DU functionality on an IAB-node is also referred to as IAB-DU and allows the downstream (toward the UE) connection to the next-hop IAB. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 performs centralized resource, topology and route management for the whole IAB topology. This includes configuring the IAB-nodes according to the network topology, e.g. in order to perform appropriate routing of data packets.

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU (e.g. of IAB-node 2), and between the IAB-donor-CU and an IAB-donor DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane, boxes 210 at the IAB-donor CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS38.473 and TS 38.401) provides signalling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the Figure stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data packets. The BAP packets are routed by the BAP layer or entity (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In upstream direction, upper layer packets are encapsulated by the BAP sublayer at an initiator IAB-node (which may be an access IAB-node should the upper layer packets come from a UE), thus forming BAP packets or data units (PDUs) or data packets. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

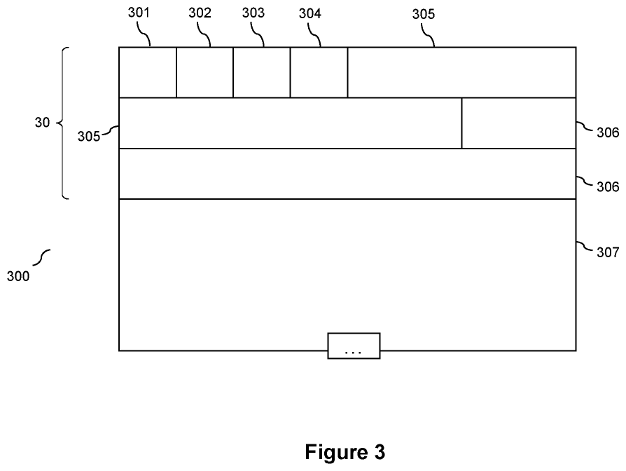

On the BAP sublayer, packets are routed based on the BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet. It is specified in the standardized version paragraph 6.2 of 3GPP TS38.340 release 16.3.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost bits.

Field 305 carries the BAP address (i.e. on the BAP sublayer) of the destination IAB-node or IAB-donor DU for the BAP packet. For the purpose of routing, each IAB-node and IAB-donor DU in an IAB network is configured (by IAB-donor CU of the IAB network) with a designated and unique BAP address. Field 306 carries a path ID identifying the routing path the BAP packet should follow to this destination in the IAB topology. For the purpose of routing, the routing paths, including their path ID, are configured (by IAB-donor-CU of the IAB network) in the IAB-nodes.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by a node, i.e. either by the IAB-donor-DU for downstream transmission or by an initiator (which may be an access IAB-node should the upper layer packets come from a UE) for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU and transmitted to the IAB-nodes to configure them.

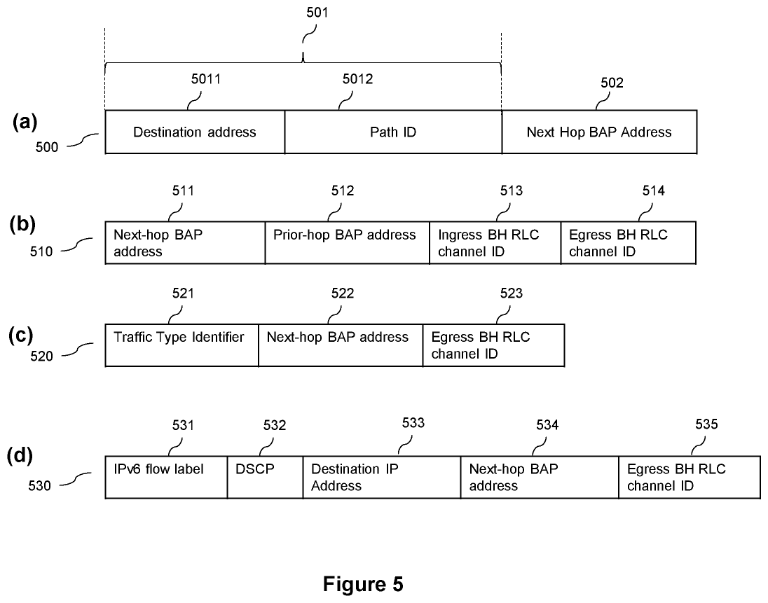

A usage of these tables (and other tables) to perform the routing is described below with reference to FIG. 5.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at emitter side; at receiver side it converts the physical modulation signals back to a stream of information. The PHY layer is described in TS 38.201, TS 38.211, TS 38.212, TS 38.213, TS 38.214.

To pass messages towards the user or control plane, two other sublayers are used in UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS38.323.

SDAP sublayer 220 for the User Plane handles the Quality of Service. It is described in TS38.324. On the UE side, the SDAP sublayer exchanges the payload data with the user's application (voice, video, etc. . . . —not shown in the Figure). On the IAB-donor CU side, the SDAP sublayer exchanges the data with the Core Network 110 (Internet traffic, Cloud, etc. . . . ).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v16.4.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

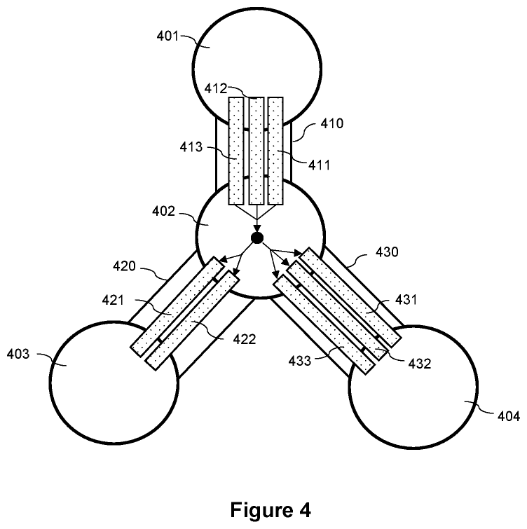

FIG. 4 illustrates a routing management in an IAB network. The routing management at an IAB-node acting as relay is based on a BAP routing configuration and seeks to determine, from one BH RLC channel of an ingress link or backhaul link over which a BAP packet is received, one BH RLC channel of one egress link or backhaul link for forwarding the received BAP packet.

A BAP routing configuration may be set manually in each IAB-node of the IAB network. Preferably, the BAP routing configurations are built and can be updated over time by IAB-donor CU and transmitted by the IAB-donor CU via F1AP signaling to the IAB-nodes during their initial configurations and the life of the IAB network. As mentioned above, the BAP routing configurations may be built by IAB-donor-CU based on the IAB network topology and its evolution over time (e.g. should some radio links disappear or recover or their link quality changes).

The BAP routing configuration of the IAB-node comprises various routing tables, four of which are shown in FIG. 5.

FIG. 5a schematically shows an entry 500 of the Backhaul Routing Configuration table as defined in 3GPP TS 38.300, V16.4.0, section 6.11.3 for the BAP sublayer. It is used by the IAB-node to select the egress link to forward or transmit a BAP packet or PDU (Protocol Data Unit).

Field 501 defines a BAP Routing ID (concatenation of the PATH field 5012 and DESTINATION field 5011, corresponding to PATH field 306 and DESTINATION field 305 as defined in FIG. 3) while field 502 specifies the next-hop BAP Address, i.e. the BAP address of the next IAB-node along the path corresponding to the Routing ID 501. The Next Hop BAP address 502 thus identifies an egress link to forward or transmit the BAP packet.

There may be several entries in the Backhaul Routing Configuration table with the same destination BAP address but with different Path IDs and next-hop BAP Addresses in the information element 502. The first entry may provide the default next-hop BAP Address corresponding to the default path to reach the destination, and the other entries with the same destination BAP address relate to back-up redundant paths to be selected when the default link is not available, e.g. because of radio link failure (RLF).

FIG. 5b schematically shows an entry 510 of the BH RLC channel mapping configuration table as defined in 3GPP TS 38.300, section 6.11.3 and/or 3GPP TS 38.340, V16.3.0, section 5.2.1.4.1, for the BAP sublayer. It is used by the IAB-node acting as a relay (e.g. an intermediate IAB-node) to identify the Backhaul (BH) RLC channel where to forward a BAP packet or PDU over the egress link previously selected using the Backhaul Routing Configuration table.

Information Element (IE) 511 stores a next-hop BAP address as defined previously and usually obtained from the Backhaul Routing Configuration table; IE 512 stores a prior-hop BAP address, i.e. the BAP address of the previous IAB-node from which the BAP packet arrives; IE 513 specifies an ingress RLC channel ID, i.e. the identifier of an RLC channel over which the BAP packet is received; and IE 514 stores an egress RLC channel ID providing the RLC channel the IAB-node will use to forward the BAP packet.

Note that for BH RLC channels in downstream direction (parent to child direction, e.g. IAB-node 402 towards IAB-node 403 in FIG. 4), the BH RLC channel ID is included in the F1AP configuration of the BH RLC channel. For BH RLC channels in upstream direction (child to parent direction, e.g. IAB-node 402 towards IAB-node 401), the BH RLC channel ID is included in the RRC configuration of the corresponding logical channel.

FIGS. 5c and 5d illustrates the equivalents to the BH RLC channel mapping configuration table for the IAB-node that does not act as intermediate IAB relaying entities. They are defined in 3GPP TS 38.340, sections 5.2.1.4.2. and section 5.2.1.4.3.

The table in FIG. 5c is called Uplink Traffic to BH RLC Channel Mapping Configuration table, 520. It is used by an initiator IAB-node (not the IAB-donor-DU) having built BAP packets or PDUs from BAP SDUs (Service Data Unit) received from upper layers, to identify the Backhaul (BH) RLC channel to transmit these packets in upstream direction over the egress link previously selected using the Backhaul Routing Configuration table described in FIG. 5a.

IE 521 specifies a Traffic Type Identifier for the SDUs received from the upper layers, IE 522 indicates a next-hop BAP address as defined previously and usually obtained from the Backhaul Routing Configuration table, and IE 523 specifies an egress BH RLC channel providing the RLC channel the IAB-node will use to transmit the BAP packet.

The table in FIG. 5d is called Downlink Traffic to BH RLC Channel Mapping Configuration table 530. It is used by the IAB-donor-DU having built BAP packets or PDUs from BAP SDUs (Service Data Unit) received from upper layers, to identify the Backhaul (BH) RLC channel to transmit these BAP packets in downstream direction over the egress link previously selected using the Backhaul Routing Configuration table.

IE 531 is an IPv6 flow label used to classify IPv6 flows, IE 532 specifies a DSCP (Differentiated Services Code Point) usually indicated in the IPv6 header of the packets, IE 533 indicates a destination IP Address, IE 534 indicates a next-hop BAP Address as defined above, and IE 535 defines an egress BH RLC channel ID providing the RLC channel the IAB-node will use to transmit the BAP packet.

The tables of FIGS. 5b, 5c and 5d may be composed of several rows (entries), each row/entry including the IEs (or fields) shown in the respective Figures.

Next-hop BAP address and egress link are synonymous because they designate the same portion (link) of the IAB network between the current IAB-node and the next IAB-node having the next-hop BAP address. Consequently, they can be used interchangeably to designate such IAB network link.

As a result of all the tables configured in the IAB-nodes and more particularly the Routing IDs of IEs 501, multiple BAP paths are defined through multiple IAB-nodes.

Back to FIG. 4, typically the routing of a BAP packet by the BAP sublayer of IAB-node 402 uses the BAP routing ID 305+306 of a BAP packet. The BAP address (DESTINATION path 305) is used for the purpose of:
1) determining whether the BAP packet has reached the destination node, i.e. IAB-node or IAB-donor DU, on BAP sublayer. The BAP packet has reached its destination node if the BAP address 305 in the packet's BAP header matches the BAP address configured either via RRC on the IAB-node or via F1AP on the IAB-donor DU.
2) determining the next-hop IAB-node for the BAP packet that has not reached its destination. This applies to BAP packets arriving from a prior-hop IAB-node over the BAP sublayer or that have been received from upper layers.

For packets arriving from a prior-hop IAB-node or from upper layers, the determination of the next-hop IBA-node is based on the Backhaul Routing Configuration table 500.

The IAB-node 402 resolves the next-hop BAP address 502 to a physical backhaul link, being either link 420 or link 430. To that end, it seeks the entry in the table 500 having field 501 matching the BAP Routing ID 305+306 of the BAP packet. Corresponding field 502 provides the next-hop BAP address.

The Backhaul Routing Configuration table may have multiple entries 500 with different BAP Routing IDs but with the same destination BAP address (meaning the BAP Path IDs are different). These entries may correspond to the same or different egress BH links. In case, the BH link matching the BAP Routing ID of the BAP packet experiences a radio link failure (RLF), typically the IAB-node may select another egress BH link (next-hop BAP address) based on routing entries with the same destination BAP address, i.e. by disregarding the BAP path ID. In this manner, a BAP packet can be delivered via an alternative path in case the indicated path is not available.

For instance, in case BH link 420 experiences a radio link failure, IAB-node 402 may select another BAP routing ID having the same destination BAP address but involving BH link 430 instead.

Next, the IAB-node 402 derives the egress BH RLC channel of the selected egress BH link, over which the BAP packet is to be transmitted or forwarded. To that end, the IAB-node 402 uses the BH RLC channel mapping configuration table or Uplink Traffic to BH RLC Channel Mapping Configuration table or Downlink Traffic to BH RLC Channel Mapping Configuration table depending on its role (intermediate or relay IAB-node, initiator IAB-node or IAB-donor-DU transmitting in uplink/upstream or downlink/downstream direction).

For instance, for an intermediate or relay IAB-node, IEs 511, 512, 513 are the inputs and IE 514 is the output of the BH RLC channel look-up process: IAB-node 402 routes the incoming BAP packets received from the ingress BH RLC channel ID 513, belonging to the ingress BH link identified by the prior-hop BAP address 512, to the egress BH RLC channel ID 514, belonging to the egress BH link previously selected and now identified by the next-hop BAP address 511.

For an initiator IAB-node wishing to transmit a BAP packet in the upstream direction to the IAB-donor, IEs 521, 522 are the inputs and IE 523 is the output of the BH RLC channel look-up process: the IAB-node 402 selects the egress BH RLC Channel 523 corresponding to the table entry 520 where the Traffic Type Identifier 521 matches the traffic type of the original BAP SDU, and where the next-hop BAP address 522 matches the next-hop BAP address previously selected with the Backhaul Routing Configuration table. This applies for BAP SDUs in the control plane (non F1-U packets), as well as for BAP SDUs in the user plane (F1-U packets). The Traffic Type Identifier 521 shall correspond to the destination IP address and TEID (Tunnel End Point Identifier) of the BAP SDUs.

For the IAB-donor-DU wishing to transmit a BAP packet in the downstream direction to a destination IAB-node or an UE, IEs 531, 532, 533, 534 are the inputs and IE 535 is the output of the BH RLC channel look-up process: IAB-node selects the egress BH RLC Channel 535 corresponding to the table entry 530 matching the Destination IP address 533, the IPv6 Flow Label 531 (only for BAP SDU encapsulating an IPv6 packet), and the Differentiated Services Code Point (DSCP) 532 of the original BAP SDU, and where the next-hop BAP address 534 matches the next-hop BAP address previously selected with the Backhaul Routing Configuration table. This applies for BAP SDUs in the control plane (non F1-U packets), as well as for BAP SDUs in the user plane (F1-U packets).

If there is no matching entry, a default BH RLC ID channel may be selected.

Such routing process can be implemented in the various IAB-nodes of an IAB network.

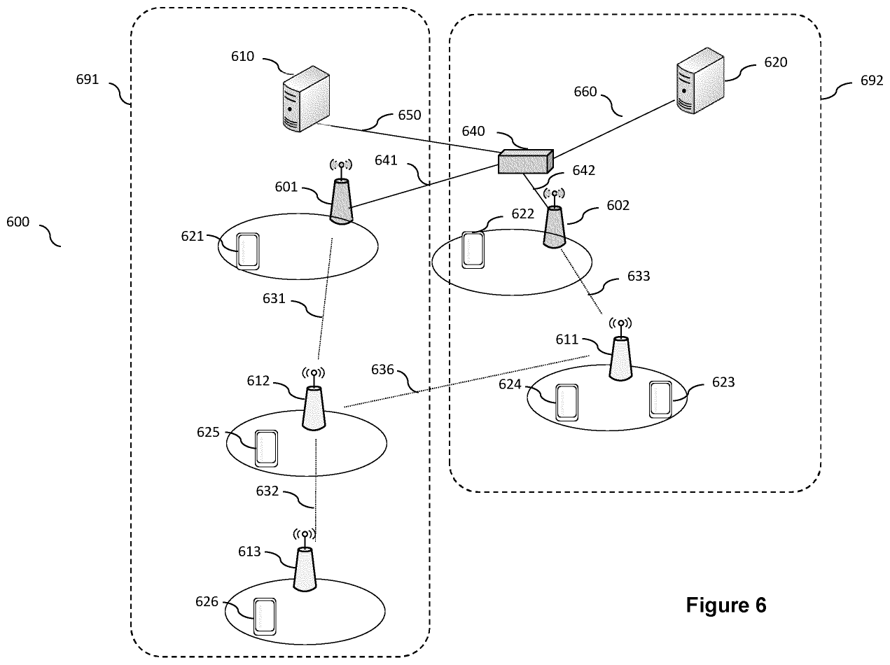

FIG. 6 illustrates an example topology 600 of an IAB network arrangement in which embodiments and examples of embodiments of the present invention may be implemented so as to provide network path diversity through the ability to route data packets across one IAB network and at least one other IAB network. In one example implementation, the BH radio links are operated over the millimeter wave frequency band (i.e. above 30 GHz), which is highly sensitive to radio channel disturbance.

IAB topology 600 includes IAB-donor-CU 610 and IAB-donor CU 620, their associated IAB-donor-DUs, IAB-donor-DU 601 (belonging to IAB-donor-CU 610), IAB-donor-DU 602 (belonging to IAB-donor-CU 620), and a plurality of IAB-nodes 611, 612 and 613, similar to IAB-nodes 121 and 122.

A wired backhaul IP network interconnects the IAB-donor-CU 610 and 620, and the IAB-donor-DUs 601 and 602 through a router 640 and the links 641, 642, 650, and 660. For instance, these wired links consist of optical fiber cables.

IAB-Donor-CU 610, IAB-Donor-DU 601, IAB-node 612 and IAB-node 613 are part of the same IAB network 691, which is configured and managed by IAB-Donor-CU 610.

IAB-Donor-CU 620, IAB-Donor-DU 602 and IAB-node 611 are part of the same IAB network 692, which is configured and managed by IAB-Donor-CU 620. IAB network 692 is different to the IAB network 691. IAB network 692 may be a neighbouring or adjacent IAB network to IAB network 691.

IAB-node 611 is connected to the parent IAB-donor-DU 602 through wireless BH link 633.

IAB-node 612 is connected to the parent IAB-donor-DU 601 through wireless BH link 631, and to the child IAB-node 613 through wireless BH link 632. Although IAB-node 612 belongs to IAB network 691, in view of its proximity to IAB network 692 and in particular to IAB-node 611, IAB-node 612 is also connected to IAB-node 611 (which acts as a parent node to IAB-node 612) through wireless BH link 636. As IAB-node 612, even though belonging to IAB network 691, is also connected to IAB-node 611, which belongs to IAB network 692, it may be referred to as a Boundary node between IAB network 691 and IAB network 692. As IAB-node 612 or Boundary node 612 is part of the IAB network 691, it is configured and managed by the IAB-Donor-CU 610 of IAB network 691. For example, the IAB-Donor-CU 610 configures the Boundary node 612 with configuration information during initial configurations and overtime to account for any changes/updates in the configurations/topologies of the IAB network 691 (and also IAB network 692 which impact the configuration of Boundary node 612). In one embodiment of the invention, IAB-node 612 is assigned two BAP addresses by IAB-donor-CU 610: one BAP address for IAB network 691 and one for IAB network 692. The IAB-donor-CU 610 will transmit the assigned BAP addresses to the Boundary node 612 in configuration messages as discussed below.

As IAB-donor-DUs 601, 602 and IAB-nodes 611, 612, 613 are respectively serving UEs 621, 622, 623, 624, 625 and 626, they also act as access IAB-nodes for the respective UEs.

Redundant paths may exist between pairs of IAB-nodes, for instance, regarding downstream paths from IAB-donor-CU 610 to IAB-node 613, a first default BAP path via an IAB-donor-DU 601 and IAB-node 612, a second BAP path via an IAB-donor-DU 602, IAB-nodes 611, and 612. Symmetrically, there are also two upstream paths involving the same nodes from IAB-node 613 to IAB-donor-CU 610.

For the exemplary description below, we consider the following downstream BAP paths:
PATH 1, associated with BAP Routing ID 2, from IAB-donor-CU 610 to IAB-node 613 via an IAB-donor-DU 601, IAB-node 612, and going through BH radio links 633, 636, and 632;
PATH 2, associated with BAP Routing ID 1, from IAB-donor-CU 620 to IAB-node 613 via an IAB-donor-DU 602 IAB-node 611 and 612, and going through BH radio links 633, 636 and 632. As PATH 2 is used to route BAP PDUs through a plurality of networks, i.e. IAB network 691 and IAB network 692, it is referred to as a Transit path.

BH radio link 631 between IAB-node 612 and IAB-donor-DU 601 may experience radio link deficiency due to some unexpected interference or shadowing phenomena, for example radio link failure, RLF. BH radio link 631 may also experience congestion at IAB-node 612.

For such reasons, the IAB-donor-CU 610 may decide, if possible, to re-route some BAP PDUs, initially planned to be routed through PATH 1, over an alternative path that would not involve BH radio link 631, e.g. PATH 2.

Also, the link 631 may be congested due to an excessive data traffic, and the IAB-donor-CU 610 may decide to offload some BAP PDUs, initially planned to be routed through PATH 1, over an alternative path, e.g. PATH 2, in order to mitigate such congestion.

The processes for managing such re-routing or offloading, are now described according to some embodiments of the present invention. The following description applies to routing data packets in the upstream or downstream direction.

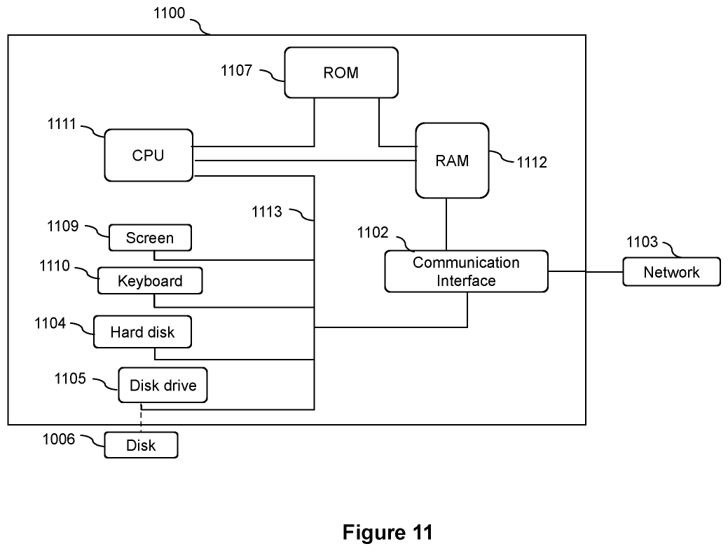

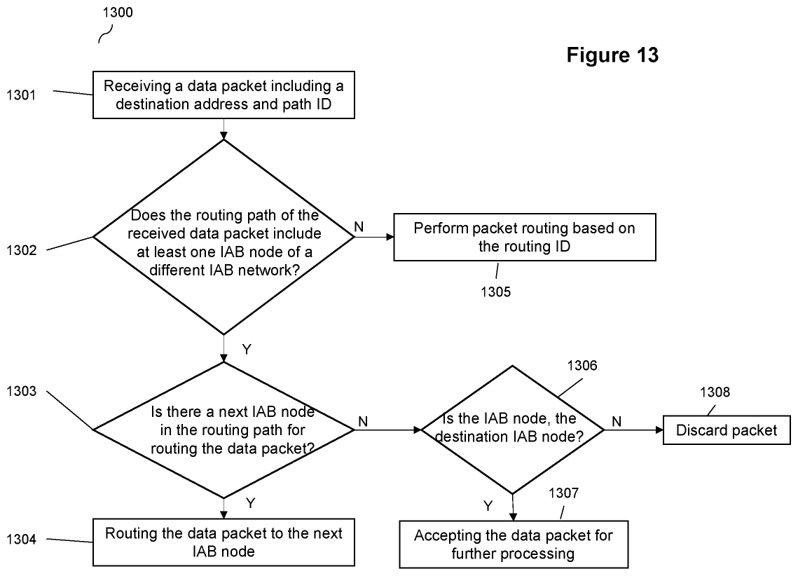

FIG. 13 shows steps of a method 1300 for processing data packets in accordance with an embodiment of the present invention. Method 1300 is performed at an IAB node of an IAB network comprising a plurality of IAB nodes. For example, the IAB node may be node 612 of IAB network 691. The IAB node may be implemented in a communication device 1100 as shown in FIG. 11 below with the method as shown in FIG. 13 being performed by the central processing unit 1111.

Briefly, in step 1301, the IAB node 612 receives a data packet (for example, a BAP packet or BAP PDU) including a destination address of a destination IAB node for the data packet and a path identifier identifying a routing path for the data packet to the destination IAB node. In an example, the data packet includes a header comprising the destination address and the path identifier which together indicate a routing identifier (e.g. fields 305 and 306 of the BAP PDU of FIG. 3). At step 1302, the IAB node 612 determines, based on the the received data packet, whether the routing path of the received data packet includes at least one IAB node of a different IAB network (e.g. IAB network 692). In other words, the IAB node 612 determines, based on the received data packet, whether the routing path of the received data packet is a transit path, where a transit path is a routing path including at least one IAB node of a different IAB network (e.g. a transit IAB network). In response to determining that the routing path of the received data packet includes at least one IAB node of a different IAB network (YES branch from step 1302), the IAB node 612 uses the path identifier of the received data packet to determine, at step 1303, whether there is a next IAB node in the routing path for routing the data packet. In an example, in order to determine whether there is a next IAB node in the routing path for the data packet (e.g. to determine the next IAB node), the IAB node 612 uses the path identifier and not the destination address of the received data packet. The IAB node 612 may only use the path identifier to determine that there is a next IAB node in the routing path for routing the data packet. When a next IAB node is determined (Yes branch from step 1303), the IAB node 612 routes the data packet to the next IAB node, step 1304. The next IAB node may be in the IAB network 691 (e.g. IAB node 613 or IAB-donor-DU 601) or may be an IAB node in IAB network 692 (e.g. IAB node 611). If at step 1302, the IAB node 612 determines that the routing path of the received data packet does not include at least one IAB node of a different IAB network (NO branch from step 1302), the IAB node 612 uses the destination address and path identifier (e.g. the routing ID) to perform packet routing, step 1305.

When a next IAB node is not determined at step 1303 (NO branch from step 1303), the IAB node 612 determines, at step 1306, whether the IAB node 612 is the destination IAB node for the data packet. If at step 1306, the IAB node 612 determines that the IAB node is the destination IAB node (YES branch from step 1306), the IAB node 612 accepts the data packet for further processing, step 1307. For example, the IAB node 612 forwards the data packet to higher layers for further processing. If at step 1306, the IAB node 612 determines that the IAB node is not the destination IAB node (NO branch from step 1306), the IAB node 612 discards the data packet, step 1308.

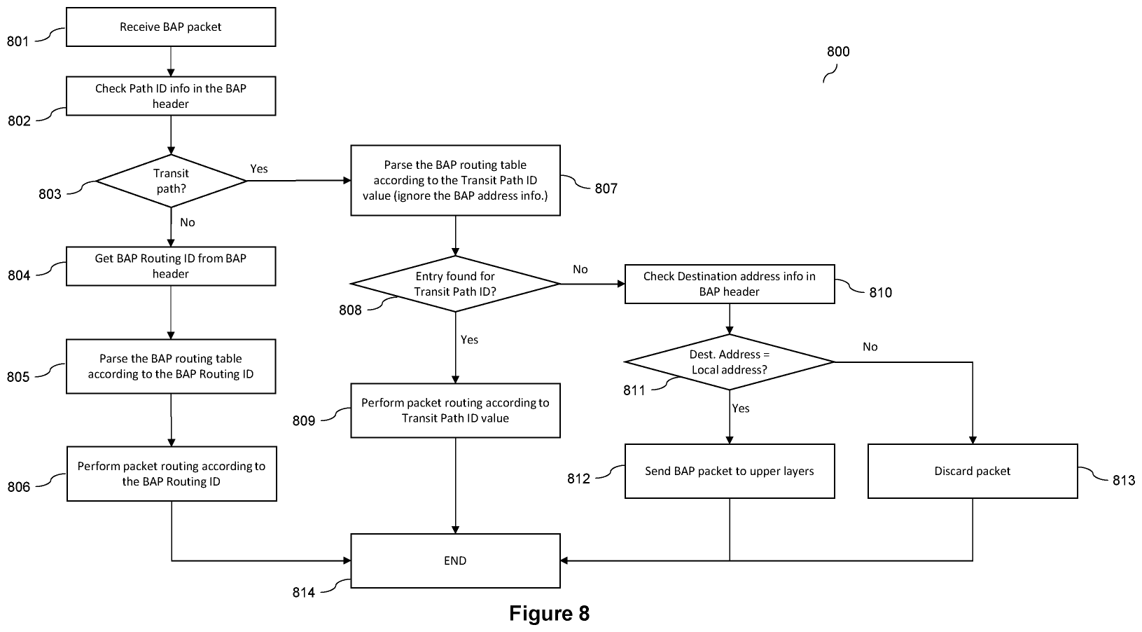

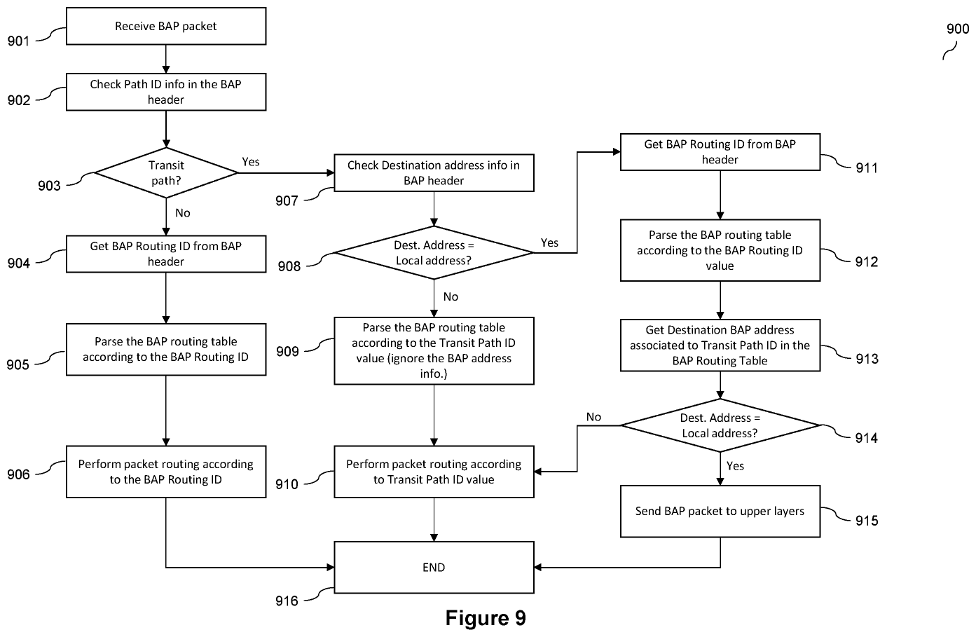

More details regarding the processing of the data packets for routing are given below with respect to the example methods shown in FIGS. 8 and 9.

As discussed above, the IAB node 612 determines whether the routing path of the received data packet includes at least one IAB node of a different IAB network using the received data packet. In other words, the IAB node 612 determines, based on the received data packet, whether the routing path of the received data packet is a transit path, where a transit path is a routing path including at least one IAB node of a different IAB network. When a data packet is routed over a transit path, the data packet is routed over a plurality of IAB networks. If a routing path of a data packet is not a transit path, the data packet is routed only within one IAB network.

In an example of an embodiment of the invention, the IAB node 612 determines whether the routing path of the received data packet includes at least one IAB node of a different IAB network using the path identifier of the received data packet. In other words, the IAB node 612 determines, based on the path identifier of the received data packet, whether the routing path of the received data packet is a transit path, where a transit path is a routing path including at least one IAB node of a different IAB network.

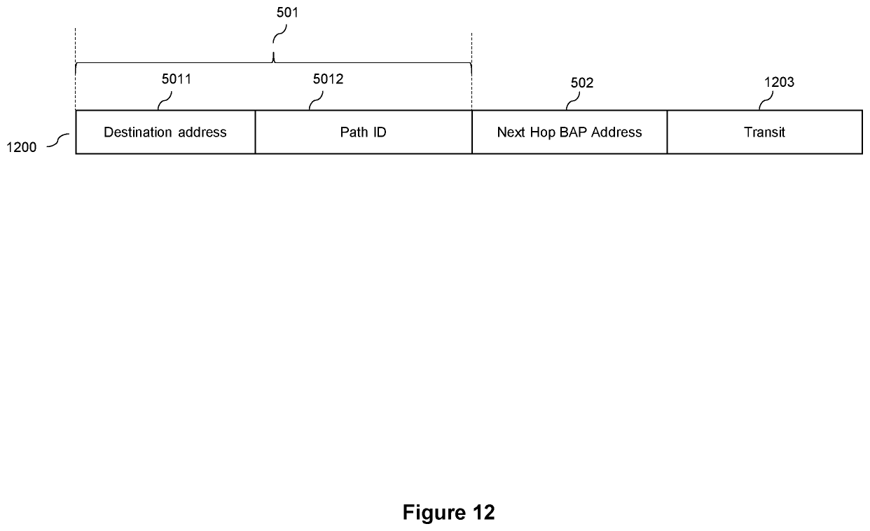

FIG. 12 shows an entry 1200 of a routing configuration table in accordance with an example of an embodiment of the invention. Routing configuration table 1200 corresponds to the entry 500 of Backhaul routing configuration table of FIG. 5a with an additional field, transit field 1203. The other fields, Routing ID field 501 (comprising destination address field 5011 and path identifier field 5012, and the next hop BAP address field 502 of the Backhaul routing configuration table of FIG. 5a are shown in FIG. 12 and designated with the same reference numerals as FIG. 5a. The transit field 1203 of the routing configuration table 1200 is for Transit path information for indicating whether the routing path identified by PATH 5012 is a Transit path or not. The transit field 1203 may be a one bit field. In one example, setting the Transit path information bit to ‘1’ can be used to indicate the routing path indicated by the path identifier in the PATH field 5012 is a Transit path, i.e. a path or routing path that is over or extends over at least two IAB networks, and setting the Transit path information bit to ‘0’ can be used to indicate the routing path indicated by the path identifier in the PATH field 5012 is not a Transit path.

With the routing configuration table 1200 configured at the IAB node 612 (e.g. by the IAB-donor-CU 610 of IAB node 612), the IAB node 612 can determine whether the routing path of the received data packet is a transit path by comparing the path identifier of the received data packet with the path identifier field 5012 of the routing configuration table 1200, and when the path identifier of the received packet matches a path identifier in the path identifier field 5012 of an entry with a value in the transit field 1203 indicating the path identifier is a transit path identifier (i.e. a path identifier for a routing path which is a transit path), the IAB node 612 can determine that the routing path of the received data packet is a transit path.

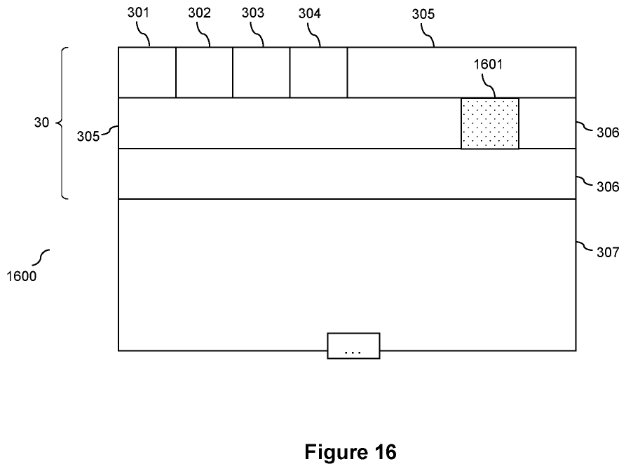

In another example of an embodiment of the invention, the data packet comprises a header including the path identifier and at least one bit configured to indicate whether the path identifier of the data packet is a transit path identifier identifying a transit path. The at least one bit may be at least one bit of the path identifier field or may be at least one reserved bit of the header, for example, as discussed below with reference to FIG. 16.

FIG. 16 shows the format of a BAP Data Protocol Data Unit (PDU) or packet in accordance with an example of an embodiment of the invention. It is specified in the standardized version paragraph 6.2 of 3GPP TS38.340 release 16.3.0. BAP Data Protocol Data Unit (PDU) format 1600 corresponds to the BAP Data Protocol Data Unit (PDU) format 300 of FIG. 3 with an additional field, transit field 1601. This field may be set by the IAB-donor DU for data packets to be communicated in the downstream direction or by an access IAB node for data packets to be communicated in the upstream direction.

The other fields 301, 302, 303, 304, 305, 306 and 307 are shown in FIG. 16 and are designated with the same reference numerals as FIG. 3. The transit field 1601 is for Transit path information for indicating whether the routing path identified by the path identifier in PATH field 306 (i.e. the path identifier in the data packet) is a Transit path or not. The transit field 1601 is a one bit field. In one example, setting the Transit path information bit to ‘1’ can be used to indicate the routing path indicated by the path identifier in the PATH field 306 is a Transit path, i.e. a path or routing path that is over or extends over at least two IAB networks, and setting the Transit path information bit to ‘0’ can be used to indicate the routing path indicated by the path identifier in the PATH field 306 is not a Transit path.

In one example of an embodiment of the invention, the transit field 1601 is one bit from the PATH field 306, e.g. the most significant bit (MSB).

In another example of an embodiment of the invention, the transit field 1601 is one out of the 4 reserved bits 301, 302, 303 and 304.

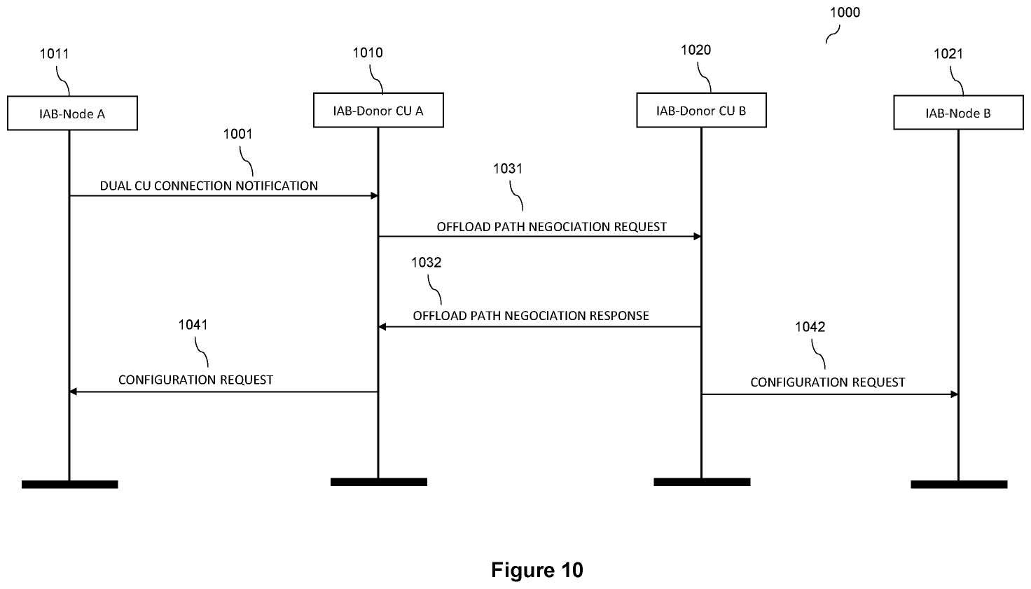

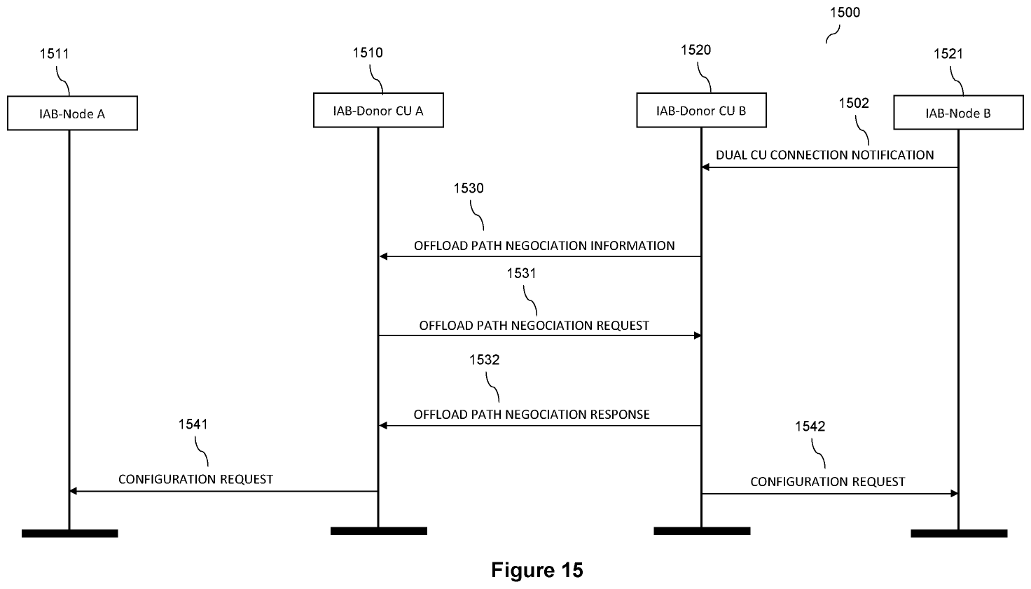

Examples of how the routing configuration table 1200 is configured by the IAB-donor-CU are described below with reference to FIG. 10 and FIG. 15. More details regarding the processing of the data packets for routing are given below with respect to the example methods shown in FIGS. 8 and 9.

In another example, one or more path identifier values of a plurality of path identifier values can be assigned to represent one or more transit path identifiers, each one of the one or more path identifier values representing a respective transit path identifier identifying a transit path. Which values are assigned to represent one or more transit path identifiers may be defined in a standard by a standards organisation (e.g. 3GPP) or may be assigned and configured by an IAB-donor-CU or may be assigned by a network operator or may be configured as a factory setting. For example, the IAB node 612 may receive routing configuration information from the IAB-donor-CU 610 with the routing configuration information indicating the one or more path identifier values assigned to the one or more transit path identifiers. Examples of how the IAB node is configured by the IAB-donor-CU are described below with reference to FIG. and FIG. 15. The routing configuration information may include a transit configuration table with each entry in the transit configuration table including a transit path identifier field for one of the one or more path identifier values assigned to represent the one or more transit path identifiers.

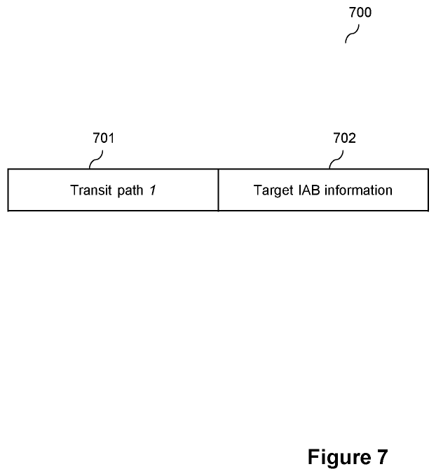

FIG. 7 illustrates an example of a transit configuration table at an IAB-node according to an example of an embodiment of the invention.

As an alternative to using at least one bit in the header of the received data packet as described above with reference to FIG. 16 or to using a transit field 1203 in each entry 1200 of the Backhaul Routing Configuration table, as described in FIG. 12, a transit configuration table or Transit Path Information Table may be used to gather the identifiers of the PATH to be used as Transit paths by an IAB-node when routing a BAP PDU, as further discussed above and in FIG. 8 and FIG. 9.

In one example, the Transit Path Information Table is configured by the IAB-donor-CU, as described in FIG. 10 or FIG. 15.

In another example, the Transit Path Information Table is configured by a network operator, as part of the Operations, Administration and Maintenance (OAM) of the network, or is a factory setting of an IAB-node.

FIG. 7 schematically shows an entry 700 of the Transit Path Information table according to some embodiments of the present invention.

Field 701 (also referred to as transit path identifier field 701) defines a TRANSIT PATH information, similar to the PATH information 5012 discussed in FIG. 5. In other words, the transit path identifier field 701 is for a path identifier as per field 5012 and in particular is for a path identifier value assigned to represent a transit path identifier for a transit path. The number of entries in the Transit Path Information table will depend on the number of path identifier values assigned to represent transit path identifiers for transit paths. When the value of a PATH information or path identifier in a BAP PDU header matches a TRANSIT PATH information value, the IAB node determines that the routing path for the data packet is a transit routing path. Thus, when the Transit Path Information table is configured at the IAB node 612 (e.g. by the IAB-donor-CU 610 of IAB node 612), the IAB node 612 can determine whether the routing path of the received data packet is a transit path by comparing the path identifier of the received data packet with the one or more path identifier values in the Transit Path Information table. When the path identifier matches one of the one or more path identifier values, the IAB node 612 determines that the routing path of the received data packet is a transit path.

The routing of the BAP PDU is processed according to the methods defined in FIG. 8 or FIG. 9 discussed below.

The Transit Path Information table of FIG. 7 also includes a field 702 (also referred to as target IAB information field) for indicating if the destination IAB-node of a BAP PDU, routed using TRANSIT PATH 701, is in the IAB network the IAB-node belongs to or if the destination IAB-node is part of another IAB network.

In one example of the invention, an entry 700 of the Transit Path Information table is made of field 701 only. In another example of the present invention, an entry 700 of the Transit Path Information table is made of both field 701 and field 702.

Examples of how the Transit Path Information table is configured by the IAB-donor-CU are described below with reference to FIG. 10 and FIG. 15.

FIG. 8 illustrates, using a flowchart 800, a first exemplary method for processing data packets (e.g. for managing BAP PDU (or data packet) routing over a plurality of IAB networks) according to embodiments and examples of the invention. For instance, a program element executed by the CPU 1111 of FIG. 11 for a BAP entity (DU or MT part) of the BAP sublayer may perform the exemplary method shown in FIG. 8. The method of FIG. 8 may be applied for routing data packets in the upstream or downstream direction.

The process starts at step 801 where an IAB-node, such as IAB node 612, receives a BAP packet, or BAP PDU.

At step 802, the IAB-node parses the header of the BAP packet and retrieves the PATH information 306 or path identifier 306.

Then, at step 803, the IAB-node determines whether the PATH information or path identifier retrieved at step 802 relates to a Transit Path. Different examples of embodiments of the invention for identifying whether the retrieved path identifier relates to a transit path have been described above. Some of these examples are mentioned briefly below.

In one example where the IAB-node is configured with a Backhaul Routing Configuration table 1200 such as that shown in FIG. 12, the IAB-node parses its Backhaul Routing Configuration table, finds an entry which PATH information matches the one retrieved from the BAP packet header and checks the Transit Path Information field 1203, as discussed with reference to FIG. 12.

In another example, the IAB-node parses its Transit Path Information Table 700 looking for an entry which PATH information matches the one retrieved from the BAP packet header, as discussed with reference to FIG. 7.

In another embodiment of the invention, the IAB-node parses the BAP PDU header, looking for the transit field 1601, as discussed with reference to FIG. 16.

If it is determined at step 803 that the BAP packet is to be routed over a non-Transit Path, the IAB-node gets the whole Routing ID information 30 from the BAP packet header (step 804) and parses its Backhaul Routing Configuration table (also referred to as routing configuration table), looking for an entry that matches this Routing ID (step 805), and performs packet routing accordingly (step 806), as discussed above with reference to FIG. 4 and to FIG. 5. An entry of the routing configuration table may correspond to entry 500 of FIG. 5a or entry 1200 of FIG. 12. If, at step 805, the DESTINATION information 305 in the BAP packet header matches the IAB-node's local BAP address, the BAP packet is sent to IAB-node's upper layers and step 806 is skipped, as the IAB-node understands that it is the actual destination of the BAP packet.

If it is determined at step 803 that the BAP packet is to be routed over a Transit Path, the IAB-node parses its Backhaul Routing Configuration table, looking for an entry 500 that matches the PATH information retrieved from the BAP packet header (step 807).

If an entry is found (step 808), the IAB-node checks the Next Hop BAP Address field 502 in the found entry and routes the BAP Packet accordingly, without considering both the value of the DESTINATION information 305 in the BAP packet header and the DESTINATION information 501 in the found entry (step 809). In other words, the IAB node determines whether there is a next IAB node for routing the data packet using the path identifier of the received data packet and by comparing the path identifier of the received data packet with the path identifier field of the routing configuration table. When the path identifier of the received data packet matches a path identifier in the path identifier field, the IAB node determines there is a next IAB node and routes the data packet to the next IAB node without using the destination address included in the data packet.

If no entry is found (step 808), the IAB-node checks the DESTINATION information 305 in the BAP packet header and compares it to its own local BAP address (step 811).

If the DESTINATION information 305 in the BAP packet header matches the IAB-node's local BAP address, the BAP packet is sent to IAB-node's upper layers (step 812), as the IAB-node understands that it is the actual destination of the BAP packet. Otherwise the BAP packet is discarded (step 813). In other words, if no entry is found at step 808, the IAB-node determines there is not a next IAB-node and depending on the comparison at step 811, either the IAB-node is the destination of the BAP packet (step 812) or the BAP packet is discarded (step 813).

The flowchart 800 ends at step 814.

FIG. 9 illustrates, using a flowchart 900, a second exemplary method for processing data packets (e.g. for managing BAP PDU (or data packets) routing over a plurality of IAB networks) according to embodiments and examples of the invention. For instance, a program element executed by the CPU 1111 of FIG. 11 for a BAP entity (DU or MT part) of the BAP sublayer may perform the exemplary method shown in FIG. 9. The method of FIG. 9 may be applied for routing data packets in the upstream or downstream direction.

The process starts at step 901 where an IAB-node, such as IAB node 612, receives a BAP packet, or BAP PDU.

At step 902, the IAB-node parses the header of the BAP packet and retrieves the PATH information 306 or path identifier 306.

Then, at step 903, the IAB-node determines whether the PATH information or path identifier retrieved at step 902 relates to a Transit Path. Different examples in accordance with embodiments of the invention for identifying whether the retrieved path identifier relates to a transit path have been described above. Some of these examples are mentioned briefly below.

In one example where the IAB-node is configured with a Backhaul Routing Configuration table 1200 such as that shown in FIG. 12, the IAB-node parses its Backhaul Routing Configuration table, finds an entry which PATH information matches the one retrieved from the BAP packet header and checks the Transit Path Information field 1203, as discussed with reference to FIG. 12.

In another example, the IAB-node parses its Transit Path Information Table 700 looking for an entry which PATH information matches the one retrieved from the BAP packet header, as discussed with reference to FIG. 7.

In another embodiment of the invention, the IAB-node parses the BAP PDU header, looking for the transit field 1601, as discussed with reference to FIG. 16.

If it is determined at step 903 that the BAP packet is to be routed over a non-Transit Path, the IAB-node gets the whole Routing ID information 30 from the BAP packet header (step 904) and parses its Backhaul Routing Configuration table (also referred to as routing configuration table), looking for an entry that matches this Routing ID (step 905), and performs packet routing accordingly (step 906), as discussed above with reference to FIG. 4 and to FIG. 5. An entry of the routing configuration table may correspond to entry 500 of FIG. 5a or entry 1200 of FIG. 12. If, at step 905, the DESTINATION information 305 in the BAP packet header matches the IAB-node's local BAP address, the BAP packet is sent to IAB-node's upper layers and step 906 is skipped, as the IAB-node understands that it is the actual destination of the BAP packet.

If it is determined at step 903 that the BAP packet is to be routed over a Transit Path, the IAB-node retrieves the DESTINATION information 305 from the BAP header (step 907) and compares it to its own local BAP address (step 908).

If the DESTINATION information 305 in the BAP packet header does not match the IAB-node's local BAP address, the IAB-node parses its Backhaul Routing Configuration table, looking for an entry 500 that matches the PATH information retrieved from the BAP packet header (step 909). In one preferred embodiment of the invention, an IAB-node has an entry configured in its Backhaul Routing Configuration table for each Transit path to be used to route BAP packets in the IAB network it belongs to.

Once an entry is found (step 910), the IAB-node checks the Next Hop BAP Address field 502 in the found entry and routes the BAP Packet accordingly, without considering both the value of the DESTINATION information 305 in the BAP packet header and the DESTINATION information 501 in the found entry.

If it is determined at step 908 that the DESTINATION information 305 in the BAP packet header matches the IAB-node's local BAP address, the IAB-node now considers the whole BAP Routing ID (i.e. DESTINATION 305 and PATH 306) in the BAP packet header (step 911) and parses its Backhaul Routing Configuration table, looking for an entry 500 that matches this Routing ID information (step 912).

In one preferred embodiment of the invention, an IAB-node has an entry configured in its Backhaul Routing Configuration table for each Transit path to be used to route BAP packets in the IAB network it belongs to.

Once an entry is found (step 913), the IAB-node gets the DESTINATION BAP address 501 associated to the Transit Path ID in the BAP Backhaul Routing Configuration Table. Then, at step 914, the IAB-node compares this DESTINATION BAP address 501 to its own local BAP address.

In one embodiment of the invention, the DESTINATION BAP address 501 associated to the Transit Path ID in the BAP Backhaul Routing Configuration Table of an IAB-node is set either 1) to the BAP address of the actual Destination IAB-node when said IAB-node and the actual Destination IAB-node belong to the same IAB network, or 2) to the address of a Boundary IAB-node in case said IAB-node and the actual Destination IAB-node do not belong to the same IAB network.

If the DESTINATION information 501 matches the IAB-node's local BAP address, and thus the DESTINATION information 305 in the BAP packet header, the BAP packet is sent to IAB-node's upper layers (step 915), as the IAB-node understands that it is the actual destination of the BAP packet.

If the DESTINATION information 501 does not match the IAB-node's local BAP address, and thus the DESTINATION information 305 in the BAP packet header, the IAB-node understands that it is not the actual destination of the BAP packet. Therefore, the BAP Packet is routed based on the Next Hop BAP Address field 502 in the entry found at step 912, without considering both the value of the DESTINATION information 305 in the BAP packet header and the DESTINATION information 501 in the found entry.

Thus, the IAB node may determine whether there is a next IAB node for routing the data packet using the path identifier of the received data packet by comparing the path identifier of the received data packet with the path identifier field of the routing configuration table. When the path identifier of the received data packet matches a path identifier in the path identifier field of an entry in the routing configuration table and when an address assigned to the IAB node does not match the address of the IAB node in the destination address field of the entry (e.g. No branch at steps 908 and 914 of FIG. 9), the IAB node determines there is a next IAB node. When the path identifier of the received data packet matches a path identifier in the path identifier field of an entry in the routing configuration table and when the destination address of the received data packet matches the address of the IAB node and the address in the destination address field of the entry (e.g. YES branch at steps 908 and 914 of FIG. 9), the IAB node determines there is not a next IAB node and the IAB node is the destination IAB node. The flowchart 900 ends at step 916.

As an illustration of the process of routing data packets over a transit path in accordance with the present invention (e.g. according to the first and second exemplary methods described above) and using the example of FIG. 6 for PATH 2 identified above, the routing configuration table (e.g. the Backhaul routing configuration table) of IAB-node 611 may include at least the following entry for the transit path identified by the path identifier PATH 2:

| BAP Routing ID | Next hop BAP address |
|---|---|
| ID 4 (BAP Address IAB-node 613 + | 2^{nd} BAP Address IAB-node 612 |
| PATH 2) | |

As discussed above, the path identifier PATH 2 in the header of the received data packet (or at least one bit in the header of the data packet) will be used to determine that the routing path for the data packet is a transit routing path. For example, by identifying that the path identifier PATH 2 is a transit path identifier. As discussed above, the IAB node 612 node may be assigned two unique addresses: one by the IAB-donor CU 610, which manages the IAB node 612 and one by the IAB-donor CU 620 of the neighbouring IAB network 692. In this example, the IAB node 612 has been assigned a unique address 1^{st} BAP Address IAB-node 612 by the IAB-donor CU 610 and has been assigned a unique address 2^{nd} BAP Address of IAB-node 612 by the IAB-donor CU 620. The unique address 2^{nd} BAP Address of IAB-node 612 is assigned by the IAB-donor CU 620 to the IAB-node 612 as a Boundary IAB node and notified to the IAB-donor CU 610 during inter-CU negotiations which are discussed in more detail below with reference to FIG. 10 and FIG. 15. The IAB-node 611 thus has the information that BAP PDUs with path identifier PATH 2 are routed toward the IAB node 612.

The routing configuration table of IAB-node 612 may include at least the following entry for the transit path identified by the path identifier PATH 2:

| BAP Routing ID | Next hop BAP address |
|---|---|
| ID 4 (BAP Address IAB-node 613 + | BAP Address IAB-node 613 |
| PATH 2) | |

As discussed above, the path identifier PATH 2 in the header of the received data packet (or at least one bit in the header of the data packet) will be used to determine that the routing path for the data packet is a transit routing path. For example, by identifying that the path identifier PATH 2 is a transit path identifier. The IAB-node 612 thus has the information that BAP PDUs with path identifier PATH 2 are routed toward the IAB node 613.

For the method of routing according to the exemplary method of FIG. 8 routing configuration table of IAB-node 613 will not include an entry for PATH 2. The IAB-node 613 thus has the information that it is the destination IAB node for BAP PDUs with path identifier PATH 2.

For the method of routing according to the exemplary method of FIG. 9 routing configuration table of IAB-node 613 may include at least the following entry:

| | |
|---|---|
| BAP Routing ID | Next hop BAP address |

ID 4 (BAP Address IAB-node 613 + PATH 2)

The IAB-node 613 thus has the information that it is the destination IAB node for BAP PDUs with path identifier PATH 2 since the destination address of the received data packet matches the address of the IAB node 613.

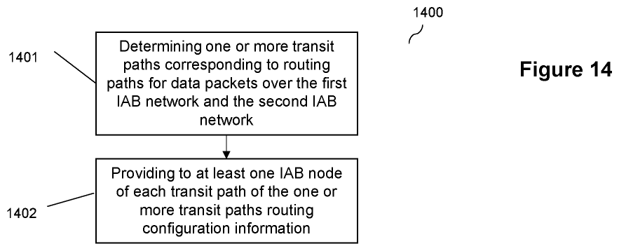

FIG. 14 shows steps of a method 1400 for managing processing of data packets in accordance with an embodiment of the present invention. Method 1400 is performed at a donor CU of a first IAB network comprising a plurality of IAB nodes. For example, the donor CU may be IAB-donor CU 610 of IAB network 691 or IAB-donor CU 620 of IAB network 692 of FIG. 6 or IAB-donor CU A 1010 or IAB-donor CUB 1020 of FIG. 10 or IAB-donor CU A 1510 or IAB-donor CU B 1521 of FIG. 15. The IAB-donor CU may be implemented in a communication device 1100 as shown in FIG. 11 below with the method as shown in FIG. 14 being performed by the central processing unit 1111.

Briefly, at step 1401, the IAB-donor CU of a first IAB network determines one or more transit paths corresponding to routing paths for routing data packets over the first IAB network and a second IAB network. Then at step 1402, the IAB-donor CU provides to at least one IAB node of each transit path of the one or more transit paths (e.g. provides to at least one IAB node of the first IAB network which IAB node is in one of the transit paths), routing configuration information relating to the determined one or more transit paths corresponding to routing paths for routing data packets over at least the at least one IAB node of the first IAB network and at least one IAB node in the second IAB network. The routing configuration information may include values of path identifiers assigned to represent transit path identifiers identifying transit paths.

In an example where the second IAB network (or could be the first IAB network) is the transit network (i.e. data packets are re-routed from the first IAB network (or could be the second IAB network) through the transit network), all of the IAB nodes in the second IAB network of a determined first transit path are configured with routing configuration information relating to the determined first transit path. And similarly for each transit path of the other determined one or more transit paths. All of the IAB nodes in the first (non-transit) IAB network of the determined first transit path may be configured with routing configuration information relating to the determined first transit path. And similarly for each transit path of the other determined one or more transit paths. In an alternative example, not all of the IAB nodes in the first (non-transit) IAB network of the determined first transit path are configured with routing configuration information relating to the determined first transit path. For this alternative example, the data packets may be routed for some of the IAB nodes of the first IAB network in the determined first transit path based on routing configuration information for routing paths only within the first IAB network (e.g. routing configuration information provided for non-transit routing paths within the first IAB network in accordance with normal procedures).

In an example, once a first IAB node, such as IAB node 612, in a first IAB network 691 establishes a connection with one or more IAB nodes, such as IAB node 611, in a different neighbouring IAB network (such as IAB network 692, hereafter referred to as the second IAB network), the IAB-donor CU 610 may receive a notification from the IAB node 612 indicating the IAB node 612 is capable of routing data packets to one or more IAB nodes in the second IAB network 692. That is, the IAB node 612 notifies the IAB-donor CU 610 that it has dual connectivity.

The IAB-donor CU 610 may then send or transmit to the IAB-donor CU 620 of the second IAB network 692 an offload notification to establish one or more transit paths. The notification may include information relating to the one or more IAB nodes of the second network to which the IAB node 612 has established a connection. The information relating to the one or more IAB nodes uniquely identifies each of the one or more nodes in the second IAB network. For each of the one or more nodes, this could be, for instance, an IP address (e.g. the IP address of the IAB-donor CU of the IAB node or the IP address of the IAB node) or a combination of a BAP address and a unique IAB network identifier. The information may also include information identifying routing paths currently in use for data packets over the first IAB network and/or information identifying possible one or more transit paths.

The IAB-donor CU 610 may then receive from the IAB-donor-CU 620 information identifying one or more transit paths corresponding to routing paths for routing data packets over at least the IAB node 612 of the first IAB network and at least one IAB node in the second IAB network. The at least one IAB node in the second IAB network may be at least one of the one or more IAB nodes to which the IAB node 612 has established a connection. The IAB-donor CU 610 may then determine one or more transit paths corresponding to routing paths for routing data packets over the first IAB network and a second IAB network using the received information identifying one or more transit paths.

In another example, once a first IAB node, such as IAB node 611, in a first IAB network 692 establishes a connection with one or more IAB nodes, such as IAB node 612, in a different neighbouring IAB network (such as IAB network 691, hereafter referred to as the second IAB network), the IAB-donor CU 620 may receive a notification from the IAB node 611 indicating the IAB node 611 is capable of routing data packets to one or more IAB nodes in the second IAB network 691. That is, the IAB node 611 notifies the IAB-donor CU 620 that it has dual connectivity.

The IAB-donor CU 620 may then send or transmit to the IAB-donor CU 610 of the second IAB network 691 an offload notification to notify the IAB-donor CU 610 of the possibility to perform offloading and to thus, establish one or more transit paths. The notification may include information identifying possible one or more transit paths.

The IAB-donor CU 620 may then receive from the IAB-donor CU 610 information relating to one or more possible transit paths corresponding to possible routing paths for routing data packets over at least the IAB node 611 of the first IAB network and at least one IAB node in the second IAB network 691. The information from the IAB-donor CU 610 relating to one or more possible transit paths may include information identifying possible one or more transit paths (e.g. if no such information is sent from the IAB-donor CU 620 in the offload notification) or may include information confirming that the possible one or more transit paths identified by information in the offload notification can be considered. The IAB-donor CU 620 may then determine one or more transit paths corresponding to routing paths for routing data packets over the first IAB network and a second IAB network using the received information relating to one or more possible transit paths. Once the IAB-donor CU 620 has determined the one or more transit paths, the IAB-donor CU 620 may send to the IAB-donor CU 610 information identifying the determined one or more transit paths corresponding to routing paths for routing data packets over at least the IAB node of the first IAB network and at least one IAB node in the second IAB network. The at least one IAB node in the second IAB network may be at least one of the one or more IAB nodes to which the IAB node 612 has established a connection.

With the offload notification from the IAB-donor CU (610 or 620), the IAB-donor CUs negotiate or share information to identify (e.g. to both IAB-donor CUs 610 and 620) routing paths that are transit paths which can be considered for routing data packets from one (i.e. 691 or 692) of the IAB networks to another (i.e. 692 or 691) of the IAB networks and the associated Boundary IAB-node(s) (e.g. IAB node 612). In one example, the unique address assigned to the Boundary IAB-node 612 by the IAB-donor-CU 610 is identified and the unique address assigned to the Boundary IAB-node 612 by the IAB-donor-CU 620 may also be identified. Based on information exchanged with the IAB-donor-CU 620, the IAB-donor CU 610 determines one or more transit paths corresponding to routing paths for data packets over at least one IAB node of the first IAB network and at least one IAB node in the second IAB network, step 1404. The the IAB-donor CU 610 also determines one or more routing paths for data packets over one or more IAB nodes within the first IAB network only (i.e. non-transit paths) as normal and IAB nodes of the first IAB network will be configured with routing configuration information for the non-transit paths as normal.

IAB-donor-CU 610 may provide to all of the IAB nodes within the IAB network 691 (e.g. via the IAB-donor-DU 601 and an intermediate IAB nodes) and which are in the one or more transit paths routing configuration information indicating (e.g. in addition to the normal routing configuration information provided to the respective IAB nodes for routing paths only within the first IAB network 691 (i.e. non-transit routing paths)) the determined one or more transit paths corresponding to routing paths for data packets over at least the IAB node 612 of the IAB network 691 and at least one IAB node in the second IAB network 692. The IAB-donor CU 620 will also transmit and send to the IAB nodes within the IAB network 692 and which are in the one or more transit paths similar routing configuration information.

In an example, one or more path identifier values of a plurality of path identifier values are assigned to represent one or more transit path identifiers, each one of the one or more path identifier values representing a respective transit path identifier identifying a transit path. The routing configuration information may comprise a routing configuration table with each entry of the routing configuration table having a destination address field for an address of an IAB node and a path identifier field for a path identifier of a routing path to the IAB node (e.g. corresponding to entry 500 of FIG. 5a) and path identifier information indicating the one or more path identifier values assigned to the one or more transit path identifiers. The path identifier information may include a transit configuration table with each entry in the transit configuration table including a transit path identifier field for one of the one or more path identifier values assigned to represent the one or more transit path identifiers (e.g. corresponding to the transit table of FIG. 7).

In another example, the routing configuration information may includes a routing configuration table with each entry of the routing configuration table having a destination address field for an address of an IAB node, a path identifier field for a path identifier of a routing path to the IAB node and a transit path field for indicating whether the path identifier in the path identifier field is a transit path identifier identifying a transit path (e.g. corresponding to entry 1200 of FIG. 12).

FIG. 10 illustrates a first exemplary message flow 1000 for managing processing of data packets (e.g. configuring and managing BAP PDU routing over a plurality of IAB networks) according to embodiments and examples of the invention. The first exemplary message flow 1000 described below with reference to FIG. 10 is a first example in accordance with the method shown in FIG. 14.

An IAB-node 1011 (such as IAB node 612), belonging to a first IAB network (such as IAB network 691), managed by a first IAB-donor CU 1010 (such as IAB-donor CU 610), may detect a second IAB-node 1021 (such as IAB node 611), belonging to a second IAB network (such as IAB network 692), managed by a second IAB-donor CU 1020 (such as IAB-donor CU 620). When the MT part of IAB-node 1011 is initially connecting to the network, it will perform a cell search procedure, as defined in 3GPP TS 38.300, trying to detect PSS (Primary Synchronization Signal) and SSS (Secondary Synchronization Signal). Based on the System information it will get, the MT unit of IAB-node 1011 will determine if it can connect to a new cell, i.e. a new IAB-node, such as IAB-node 1021.

If it succeeds to establish connectivity with IAB-node 1021, IAB-node 1011 may notify its IAB-donor CU 1010 that it has established dual connectivity with an IAB-node that belongs to a neighbor IAB network by sending a DUAL CU CONNECTION NOTIFICATION message 1001. In other words, the IAB-node 1011 may transmit a notification to the donor Central Unit, CU, of the first IAB network, indicating the IAB node 1011 is capable of routing data packets to one or more IAB nodes in the second IAB network (e.g. a transit IAB network). IAB-node 1011 can thus be considered as a Boundary IAB-node, as discussed above with reference to FIG. 6.

Message 1001 from IAB-node 1011 may embed information that uniquely identifies IAB-node 1021 in the second IAB network. This could be, for instance, an IP address (the one of IAB-donor CU 1020 or the one of IAB-node 1021) or a combination of a BAP address and a unique IAB network identifier.

Upon reception of a DUAL CU CONNECTION NOTIFICATION message 1001, IAB-donor CU 1010 may initiate the establishment of transit paths, for example PATH 2 as defined above with reference to FIG. 6, by sending an offload notification, such as the OFFLOAD PATH NEGOCIATION REQUEST message 1031, to the IAB-Donor CU 1020.

In one example of an embodiment of the invention, message 1031 is the Measurement report message, as defined in 3GPP TS 38.331 V16.3.1 specification.

The offload notification or message 1031 may include information relating to the one or more IAB nodes in the second IAB network to which the IAB-node 1011 is capable of routing data packets. For example, the message 1031 embeds IAB-node information that identifies IAB-node 1021 as an IAB-node being connected to Boundary node 1011. Such information includes, for instance, the IP address of IAB-node 1021, the IP address of IAB-node 1011, the BAP address of IAB-node 1021, the BAP address of IAB-node 1011, or any combination thereof.

In one example of an embodiment of the invention, message 1031 may include Transit path Information, which may include a list of all the PATH or routing paths currently in use in the first IAB network, or a list of potential Transit paths, which may be used for routing BAP PDUs from the first (resp. second) IAB network to the second (resp. first) IAB network. For example, such as transit path PATH 2 as defined above with reference to FIG. 6. It may also include a QoS level associated to the BAP packets to be routed using the Transit paths. It may also include some information related to the nature of the communication, i.e. downstream or upstream.

In one example of an embodiment of the invention, message 1031 may include, in addition to the Transit path Information discussed above, the DESTINATION BAP address of the Destination IAB-node to be reached through a Transit path (for downstream communication).

Upon reception of an OFFLOAD PATH NEGOCIATION REQUEST message 1031, IAB-donor CU 1020 may determine a set of BAP routing paths that allow conveying BAP PDUs through the first IAB network managed by IAB-donor CU 1010 and the second IAB network managed by IAB-donor CU 1020. To do so, IAB-donor CU 1020 selects one or more Transit Paths, for example PATH 2 as defined above with reference to FIG. 6. In other words, the IAB-donor CU 1020 may determine one or more transit paths corresponding to routing paths for routing data packets over the first IAB network (such as 691) and the second IAB network (such as 692) by selecting one or more of the transit paths out of the possible transit paths identified (e.g. in the Transit paths proposal).

Then, the IAB-donor CU 1020 sends an OFFLOAD PATH NEGOCIATION RESPONSE message 1032 to the IAB-donor CU 1010.

Message 1032 embeds Transit Routing Information that identifies the determined Transit path(s) that can be considered for routing BAP PDUs from first (resp. second) IAB network to second (resp. first) IAB network along with the associated Boundary IAB-node(s). Such information includes, for instance, a list of Transit Path value(s) (i.e. the values of the path identifiers that assigned to represent transit path identifiers, which identify routing paths as transit paths) associated to Boundary IAB-node 1011.

In one embodiment of the invention, message 1032 may also include a BAP address for IAB-node 1011, to be used by the IAB-nodes of the second IAB network, like IAB-node 1021, to route BAP PDUs to/from the first IAB network. Thus, Boundary IAB node 1011 (such as IAB node 612) may have a first unique address assigned to it by IAB-donor-CU 1010 (such as IAB-donor-CU 610) for use by the first IAB network (such as IAB network 691) and a second unique address assigned to it by IAB-donor-CU 1020 (such as IAB-donor-CU 620) for use by the second IAB network (such as IAB network 692). It may also include ingress and egress BH RLC Channel ID to be used by IAB-node 1011 (to fill in table 510, or 520 as described above with reference to FIG. 5).

In one example of an embodiment of the invention, message 1032 may include, in addition to the Transit Routing Information discussed above, the DESTINATION BAP address of the Destination IAB-node to be reached through a Transit path (for upstream communication).

Upon reception of an OFFLOAD PATH NEGOCIATION RESPONSE message 1032, the IAB-donor CU 1010 may determine one or more transit paths using the information received from the IAB-donor CU 1020 in the OFFLOAD PATH NEGOCIATION RESPONSE message 1032 and may configure new entries of the Backhaul Routing Configuration table of the IAB-nodes in the first IAB network, like IAB-node 1011, to configure the transit path(s) negotiated with IAB-donor CU 1020, by sending a CONFIGURATION REQUEST message 1041. For example, the IAB-donor CU 1010 may configure, for example in a transit configuration table such as that described above with reference to FIG. 7, routing configuration information indicating the one or more path identifier values assigned to the one or more transit path identifiers, and new entries of the routing configuration table corresponding to entry 500 of FIG. 5a or may configure new entries of the routing configuration table corresponding to entry 1200 of FIG. 12.

Once having transmitted an OFFLOAD PATH NEGOCIATION RESPONSE message 1032, the IAB-donor CU 1020 may configure new entries of the Backhaul Routing Configuration table of the IAB-nodes in the second IAB network, like IAB-node 1021, to configure the transit path(s) negotiated with IAB-donor CU 1010, by sending a CONFIGURATION REQUEST message 1042. For example, the IAB-donor CU 1020 may configure, for example in a transit configuration table such as that described above with reference to FIG. 7, routing configuration information indicating the one or more path identifier values assigned to the one or more transit path identifiers, new entries of the routing configuration table corresponding to entry 500 of FIG. 5a or to entry 1200 of FIG. 12).

FIG. 15 illustrates a second exemplary message flow 1500 for managing processing of data packets (e.g. configuring and managing BAP PDU routing over a plurality of IAB networks) according to embodiments and examples of the invention. The second exemplary message flow 1000 is a second example in accordance with the method shown in FIG. 14.

An IAB-node 1521 (such as IAB node 611), belonging to a first IAB network (such as IAB network 692), managed by a first IAB-donor CU 1520 (such as IAB-donor CU 620), may detect a second IAB-node 1511 (such as IAB node 612), belonging to a second IAB network (such as IAB network 691), managed by a second IAB-donor CU 1020 (such as IAB-donor CU 620). When the MT part of IAB-node 1521 is initially connecting to the network, it will perform a cell search procedure, as defined in 3GPP TS 38.300, trying to detect PSS (Primary Synchronization Signal) and SSS (Secondary Synchronization Signal). Based on the System information it will get, the MT unit of IAB-node 1521 will determine if it can connect to a new cell, i.e. a new IAB-node, such as IAB-node 1511.

If it succeeds to establish connectivity with IAB-node 1511, IAB-node 1521 may notify its IAB-donor CU 1520 that it has established dual connectivity with an IAB-node that belongs to a neighbor IAB network by sending a DUAL CU CONNECTION NOTIFICATION message 1502. In other words, the IAB-node 1521 may transmit a notification to the donor Central Unit, CU, of the first IAB network, indicating the IAB node 1521 is capable of routing data packets to one or more IAB nodes in the second IAB network. IAB-node 1521 can thus be considered as a Boundary IAB-node, as discussed above with reference to FIG. 6.

Message 1502 from IAB-node 1521 may embed information that uniquely identifies IAB-node 1511 in the second IAB network. This could be, for instance, an IP address (the one of IAB-donor CU 1510 or the one of IAB-node 1511) or a combination of a BAP address and a unique IAB network identifier.

Upon reception of a DUAL CU CONNECTION NOTIFICATION message 1502, IAB-donor CU 1520 may initiate the establishment of transit paths, for example PATH 2 as defined above with reference to FIG. 6, by sending an offload notification, such as the OFFLOAD PATH NEGOCIATION INFORMATION message 1530, to the IAB-Donor CU 1510. This message is used to notify IAB-donor CU 1510 of the possibility to perform offloading. The offload notification or message 1530 may include information which is similar to the information carried by message 1032 discussed above in FIG. 10 except that instead of the Transit Routing Information that is included in message 1032, the offload notification or message 1530 may include a Transit Paths proposal made to IAB-donor CU 1510. For example, the offload notification or message 1530 may include a Transit Paths proposal comprising information identifying possible one or more transit paths. For example, such as transit path PATH 2 as defined above with reference to FIG. 6. Alternatively, the offload notification or message 1530 may not include a Transit Paths proposal. The offload notification or message 1530 may include a list of all the PATH or routing paths currently in use in the first IAB network.

Upon reception of an OFFLOAD PATH NEGOCIATION INFORMATION message 1530, IAB-donor CU 1510 responds by sending an OFFLOAD PATH NEGOCIATION REQUEST message 1531, to the IAB-Donor CU 1520.

In one example of an embodiment of the invention, message 1531 is the Measurement report message, as defined in 3GPP TS 38.331 V16.3.1 specification.

The OFFLOAD PATH NEGOCIATION REQUEST message 1531 may include information relating to the one or more possible transit paths corresponding to possible routing paths for routing data packets over at least the IAB node 1521 of the first IAB network and at least one IAB node (e.g. 1511) in the second IAB network. The information in the OFFLOAD PATH NEGOCIATION REQUEST message 1531 from the IAB-donor CU 1510 relating to one or more possible transit paths may include information identifying possible one or more transit paths (e.g. if no such information is sent from the IAB-donor CU 1520 in the offload notification or message 1530) or may include information confirming that the possible one or more transit paths identified by information in the offload notification can be considered. The OFFLOAD PATH NEGOCIATION REQUEST message 1531 is similar to message 1031 of FIG. 10. In such case, the information in the OFFLOAD PATH NEGOCIATION REQUEST message 1531 corresponds to the Transit Path Information which is sent in the message 1031 and as discussed above, the Transit Path Information is either 1) a confirmation of the transit paths proposed in message 1530 or 2) a proposal of Transit paths (as for 1031).

The OFFLOAD PATH NEGOCIATION REQUEST message 1531 may include information relating to the one or more IAB nodes in the second IAB network to which the IAB-node 1521 is capable of routing data packets. For example, the message 1531 embeds IAB-node information that identifies IAB-node 1511 as an IAB-node being connected to Boundary node 1521. Such information includes, for instance, the IP address of IAB-node 1511, the IP address of IAB-node 1521, the BAP address of IAB-node 1511, the BAP address of IAB-node 1521, or any combination thereof.

In one example of an embodiment of the invention, message 1531 may include, in addition to the Transit path Information discussed above, the DESTINATION BAP address of the Destination IAB-node to be reached through a Transit path (for downstream communication).

Upon reception of an OFFLOAD PATH NEGOCIATION REQUEST message 1531, IAB-donor CU 1520 may determine a set of BAP routing paths that allow conveying BAP PDUs through the first IAB network managed by IAB-donor CU 1520 and the second IAB network managed by IAB-donor CU 1510. To do so, IAB-donor CU 1520 selects one or more Transit Paths, for example PATH 2 as defined above with reference to FIG. 6. In other words, the IAB-donor CU 1520 may determine one or more transit paths corresponding to routing paths for routing data packets over the first IAB network (such as 692) and the second IAB network (such as 691) by selecting one or more of the transit paths out of the possible transit paths identified (e.g. in the Transit paths proposal).

Then, the IAB-donor CU 1020 sends an OFFLOAD PATH NEGOCIATION RESPONSE message 1532 to the IAB-donor CU 1510. This message 1532 is similar to the message 1032 of FIG. 10.

Message 1532 embeds Transit Routing Information that identifies the determined Transit path(s) that can be considered for routing BAP PDUs from first (resp. second) IAB network to second (resp. first) IAB network along with the associated Boundary IAB-node(s). Such information includes, for instance, a list of Transit Path value(s) (i.e. the values of the path identifiers that assigned to represent transit path identifiers, which identify routing paths as transit paths) associated to Boundary IAB-node 1011.

In one embodiment of the invention, message 1532 may also include a BAP address for IAB-node 1521, to be used by the IAB-nodes of the second IAB network, like IAB-node 1511, to route BAP PDUs to/from the first IAB network. Thus, Boundary IAB node 1521 (such as IAB node 611) may have a first unique address assigned to it by IAB-donor-CU 1020 (such as IAB-donor-CU 620) for use by the first IAB network (such as IAB network 692) and a second unique address assigned to it by IAB-donor-CU 1510 (such as IAB-donor-CU 610) for use by the second IAB network (such as IAB network 691). It may also include ingress and egress BH RLC Channel ID to be used by IAB-node 1521 (to fill in table 510, or 520 as described above with reference to FIG. 5).

In one example of an embodiment of the invention, message 1532 may include, in addition to the Transit Routing Information discussed above, the DESTINATION BAP address of the Destination IAB-node to be reached through a Transit path (for upstream communication).

Upon reception of an OFFLOAD PATH NEGOCIATION RESPONSE message 1532, the IAB-donor CU 1510 may determine one or more transit paths using the information received from the IAB-donor CU 1520 in the OFFLOAD PATH NEGOCIATION RESPONSE message 1532 and may configure new entries of the Backhaul Routing Configuration table of the IAB-nodes in the second IAB network, like IAB-node 1511, to configure the transit path(s) negotiated with IAB-donor CU 1520, by sending a CONFIGURATION REQUEST message 1541. For example, the IAB-donor CU 1510 may configure, for example in a transit configuration table such as that described above with reference to FIG. 7, routing configuration information indicating the one or more path identifier values assigned to the one or more transit path identifiers, and new entries of the routing configuration table corresponding to entry 500 of FIG. 5a or may configure new entries of the routing configuration table corresponding to entry 1200 of FIG. 12.

Once having transmitted an OFFLOAD PATH NEGOCIATION RESPONSE message 1532, the IAB-donor CU 1520 may configure new entries of the Backhaul Routing Configuration table of the IAB-nodes in the first IAB network, like IAB-node 1521, to configure the transit path(s) negotiated with IAB-donor CU 1510, by sending a CONFIGURATION REQUEST message 1542. For example, the IAB-donor CU 1520 may configure, for example in a transit configuration table such as that described above with reference to FIG. 7, routing configuration information indicating the one or more path identifier values assigned to the one or more transit path identifiers, new entries of the routing configuration table corresponding to entry 500 of FIG. 5a or to entry 1200 of FIG. 12).

The second exemplary message flow shown in FIG. 15 may be used when a transit IAB network initiates inter-CU negotiations to establish transit paths between two IAB networks. In such a case, the transit network is the first IAB network and the other IAB network (non-transit network) is the second IAB network such that data packets are re-routed from the second IAB network (non-transit network) through the first IAB network (transit network).

In one example of an embodiment of the invention, the CONFIGURATION REQUEST message 1041 (resp. 1042) and 1541 (resp. 1542) is a BAP MAPPING CONFIGURATION message, as described in 3GPP TS 38.473 v16.4.0.

In one example of an embodiment of the invention, messages 1001, 1041 and 1042 and messages 1502, 1541 and 1542 are RRC messages, as defined in 3GPP TS 38.331 V16.3.1 specification.

In one example of an embodiment of the invention, messages 1031 and 1032 and messages 1530, 1531, and 1532 are Xn-C messages, as defined in 3GPP TS 38.420 specification.

In the context of inter-topology BAP routing (e.g. inter-IAB network BAP routing), one may observe that, since assignment of BAP addresses, BAP path IDs and BH RLC CH IDs is managed independently in each topology (e.g. each IAB network), the same values may be reused. This may lead to collisions among BAP addresses, BAP path IDs and BH RLC CH IDs when performing BAP routing across two topologies.

For instance, if a Boundary IAB-node of a first IAB network has the same address as an IAB-node in the second IAB network, when the Boundary IAB-node receives a BAP PDU with a header that includes a destination BAP address that matches the address of the Boundary IAB-node (and hence the address of the IAB-node in the second IAB network), the Boundary node will not be able to decide whether the BAP PDU is for the Boundary IAB-node and so has to be forwarded to upper layers or is intended for the IAB-node in the second IAB network and so has to forwarded to the next hop.

Therefore, one may observe that the BAP address cannot be used to differentiate between any two destination nodes.

BAP address space may be split into different partitions through a CU identifier, or separate sets of BH RLC channels may be introduced to prevent any routing ambiguity. However, such solutions require the coordination of the different donor-CUs through a standardized signalling, as well as the need of IAB-nodes reconfiguration when a conflict is detected in the allocation of addresses or IDs. Besides, extending the BAP header (e.g. for CU-related identifier addition purpose) to allow topology differentiation would create BAP packet overhead.

To overcome the aforementioned drawbacks, a solution is to let the BAP addresses, BAP path IDs and BH RLC CH IDs be assigned independently in each topology while the boundary node holds a mapping table, which maps the BAP routing ID from one topology to the BAP routing ID in the other topology. Then, the BAP routing ID carried on the BAP header is rewritten by the boundary node when a BAP PDU crosses the boundary node from one topology to the other. The disadvantage of this approach is that it requires the boundary IAB node to perform significant processing to re-write the BAP headers.

More generally speaking, one may observe that BAP header re-writing would require extra processing and complexity at boundary node.

To solve the above issues, it is proposed to rely on dedicated path identifiers, referred to as Transit path identifiers, to be specifically used for routing BAP packets across two topologies.

When determining that the routing path in a BAP packet header is a Transit path, i.e. is to be routed through two IAB networks, an IAB-node would route this BAP packet regardless of the Destination address in the BAP packet header.

In order to prevent inappropriate re-routing that would result from an address collision (e.g. a relay IAB-node in a first topology has the same address as the actual destination IAB-node in a second topology), an IAB-node would parse its BAP routing configuration table, based on the Path ID in the BAP packet header, to determine whether a received BAP packet is to be relayed or sent to the upper layers.

Two options are proposed hereafter which illustrate how the use of Transit paths could allow BAP routing across two topologies, without having the need for any BAP header re-writing.

### Option 1

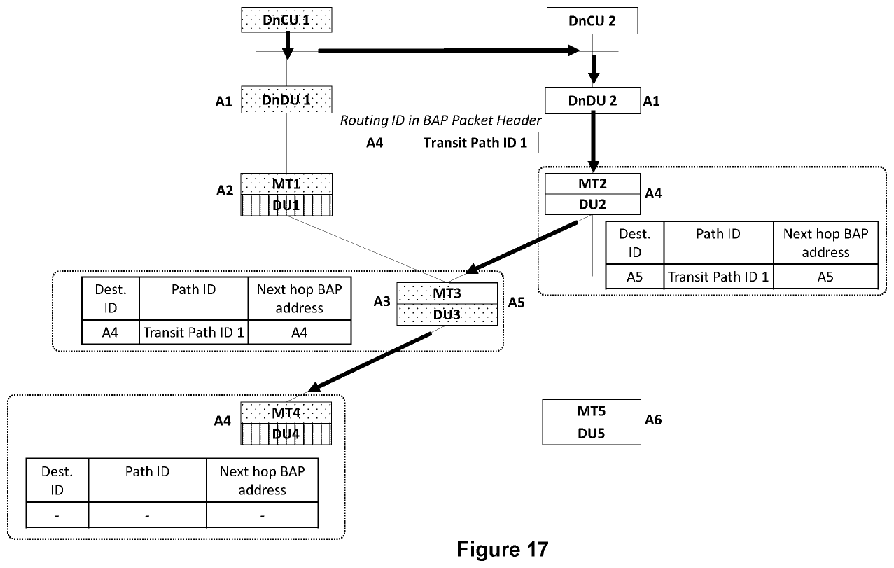

As illustrated in FIG. 17, the IAB-donor 1, in charge of IAB topology 1, wishes to offload some BAP packets, destined to IAB-node 4, by routing them through the IAB-donor 2, in charge of IAB topology 2. To do so, the BAP packet header has its Destination field value set to “A4”, which is the address of IAB-node 4, and its Path field value set to “Transit Path ID 1” value by IAB-donor 2. Thus, no additional field is required in the BAP header format to notify a transit path.

In the following, IAB-node 2, belonging to IAB topology 2, has been assigned the same address “A4” as IAB-node-4, which belongs to IAB topology 1.

IAB-node 2, upon reception of the BAP packet, identifies that a Transit Path, i.e. Transit Path ID 1, is used to route the packet. Therefore, it does not consider the Destination field in the BAP header, but rather checks for the entry in the BAP routing configuration table which Path ID field matches “Transit Path ID 1”. This entry indicates that the packet should be forwarded to IAB-node 3, which BAP address “A5” (in IAB topology 2) matches the Next hop BAP address field in the table.

Boundary IAB-node 3, upon reception of the BAP packet, identifies that a Transit Path, i.e. Transit Path ID 1, is used to route the packet. Therefore, it performs the same operation as IAB-node 2 did previously and forwards the BAP packet to IAB-node 4, which BAP address “A4” matches the Next hop BAP address field in its BAP routing configuration table.

IAB-node 4, upon reception of the BAP packet, identifies that a Transit Path, i.e. Transit Path ID 1, is used to route the packet. Therefore, IAB-node 4 checks for the entry in the BAP routing configuration table which Path ID field matches “Transit Path ID 1”. As it finds no entry, IAB-node 4 checks the Destination field in the BAP header and, as it matches its own BAP address value, deduces that it should send the BAP packet to its upper layers.

According to Option 1, no header rewriting is needed at boundary node.

According to Option 1, no configuration is specific to the boundary node.

The method described above with reference to FIG. 8 is an example of Option 1.

### Option 2

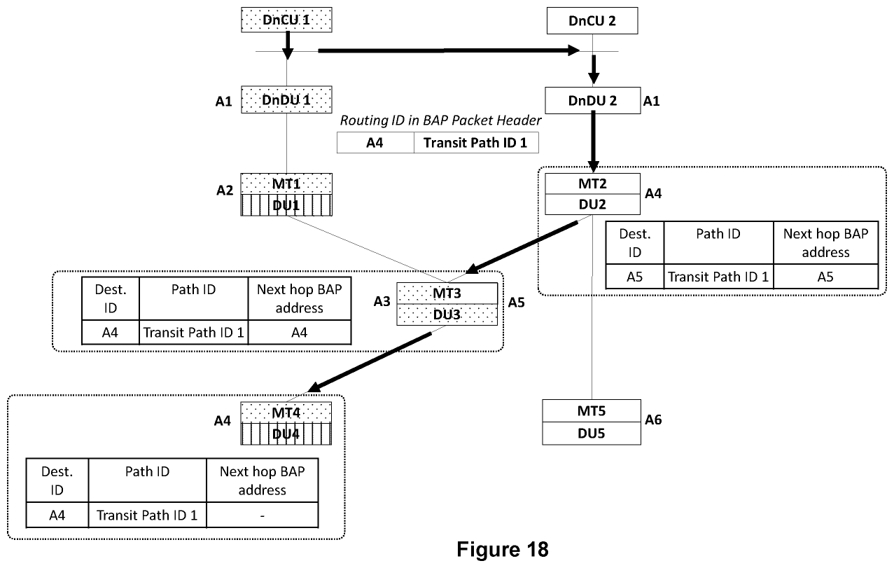

As illustrated in FIG. 18, the IAB-donor 1, in charge of IAB topology 1, wishes to offload some BAP packets, destined to IAB-node 4, by routing them through the IAB-donor 2, in charge of IAB topology 2. To do so, the BAP packet header has its Destination field value set to “A4”, which is the address of IAB-node 4, and its Path field value set to “Transit Path ID 1” by IAB-donor 2.

In the following, IAB-node 2, belonging to IAB topology 2, has been assigned the same address “A4” as IAB-node-4, which belongs to IAB topology 1.

IAB-node 2, upon reception of the BAP packet, identifies that a Transit Path, i.e. Transit Path ID 1, is used to route the packet. It also detects that its own BAP address “A4” matches the Destination field value in the BAP header.

IAB-node 2 checks for the entry in the BAP routing configuration table which Path ID field matches “Transit Path ID 1”. As the Destination field in this entry (i.e. “A5”) does not match its own BAP address, IAB-node 2 understands that the packet should be forwarded to IAB-node 3, which BAP address “A5” (in IAB topology 2) matches the Next hop BAP address field in the table.

Boundary IAB-node 3, upon reception of the BAP packet, identifies that a Transit Path, i.e. Transit Path ID 1, is used to route the packet. As the Destination field “A4” in the BAP header does not match its own BAP address “A5”, IAB-node 3 checks for the entry in its BAP routing configuration table which Path ID field matches “Transit Path ID 1”. This entry indicates that the packet should be forwarded to IAB-node 4, which BAP address “A4” matches the Next hop BAP address field in the table.

IAB-node 4, upon reception of the BAP packet, identifies that a Transit Path, i.e. Transit Path ID 1, is used to route the packet. It also detects that its own BAP address “A4” matches the Destination field value in the BAP header.

IAB-node 4 checks for the entry in the BAP routing configuration table which Path ID field matches “Transit Path ID 1”. As the Destination field in this entry (i.e. “A4”) matches its own BAP address (and thus the Destination field value in the BAP header), IAB-node 4 deduces that it should send the BAP packet to its upper layers.

According to Option 2, no header rewriting is needed at boundary node.

According to Option 2, no specific configuration is needed at boundary node.

The method described above with reference to FIG. 9 is an example of Option 2.

In relation with the above observations, it is therefore proposed that specific Transit Path IDs are used for performing BAP routing across two topologies. Thus, no BAP header re-writing is needed.

It is also proposed that an IAB-node parses its BAP routing configuration table according to the Path ID, instead of the full routing ID, when routing a BAP packet which Path field in the BAP header is set to a path ID which refers to a Transit Path.

Identifying a Transit path at an IAB-node may require some prior configuration from the IAB-donor CU. In this respect, IAB-donor CU 1 and IAB-donor CU 2 (see also FIG. 1 and FIG. 2) may negotiate a set of path IDs to be used as Transit paths for data packets offloading purpose between IAB topology 1 and IAB topology 2.

As a first option, one additional Transit path information field may be added to each entry of the Backhaul Routing Configuration table of an IAB-node, which indicates whether the associated Path field value set in the entry refers to a Transit path or not. An IAB-donor CU may then configure this Transit path information using the BAP MAPPING CONFIGURATION message.

It is therefore proposed that a Transit path information field may be added to each entry of the Backhaul Routing Configuration table of an IAB-node/IAB-donor-DU.

As a second option, a specific Transit paths table that would gather the list of the Transit Path IDs negotiated between IAB-donor 1 and IAB-donor 2 may be configured at each IAB-node. An IAB-donor CU may then configure this Transit paths table using the BAP MAPPING CONFIGURATION message.

It is therefore proposed that a specific Transit path table, which gathers the list of the Transit path IDs to be used by the IAB-donor CU, may be configured at each IAB-node by the IAB-donor CU.

Eventually, in order to alleviate the protocol interactions between IAB-donor CU 1 and IAB-donor CU 2, a dedicated set of path IDs may be reserved in the standard for Transit Path IDs.

It is therefore proposed that a set of dedicated Path IDs may be reserved in the standard for Transit path IDs.

FIG. 11 shows a schematic representation of an example communication device or station, in accordance with one or more embodiments and examples of the present disclosure.

The communication device 1100 may preferably be a device such as a micro-computer, a workstation or a light portable device. The communication device 1100 comprises a communication bus 1113 to which there are preferably connected:
a central processing unit 1111, such as a microprocessor, denoted CPU;
memory for storing data and computer programs containing instructions for the operation of the communication device 1100. The computer programs may contain a number of different program elements or sub-routines containing instructions for a variety of operations and for implementing the invention. For example, the program elements include an element to implement a BAP entity which as discussed above is for routing of data packets between different network nodes in the IAB network; and
at least one communication interface 1102 connected to the radio communication network 100 over which digital data packets or frames or control frames are transmitted, for example a wireless communication network according to the release 16 for 5G NR. The frames are written from a FIFO sending memory in RAM 1112 to the network interface for transmission or are read from the network interface for reception and writing into a FIFO receiving memory in RAM 1112 under the control of a software application running in the CPU 1111.

Each of a donor CU, an IAB network node and a donor DU may comprise such a communication device 1100.

The central processing unit 1111 may be a single processor or may comprise two or more processors carrying out the processing required for the operation of the communication device 1100. The number of processors and the allocation of processing functions to the central processing unit 1111 is a matter of design choice for a skilled person.

The memory may include:
a read only memory 1107, denoted ROM, for storing computer programs for implementing the invention;
a random-access memory 1112, denoted RAM, for storing the executable code of methods according to one or more embodiments of the invention as well as the registers adapted to record variables and parameters necessary for implementing methods according to one or more embodiments of the invention.

Optionally, the communication device 1100 may also include the following components:
a data storage means 1104 such as a hard disk, for storing computer programs for implementing methods according to one or more embodiments of the invention;
a disk drive 1105 for a disk 1106, the disk drive being adapted to read data from the disk 1106 or to write data onto said disk;
a screen 1109 for displaying decoded data and/or serving as a graphical interface with the user, by means of a keyboard 1110 or any other pointing means.

Preferably the communication bus provides communication and interoperability between the various elements included in the communication device 1100 or connected to it. The representation of the bus is not limiting and in particular, the central processing unit is operable to communicate instructions to any element of the communication device 1100 directly or by means of another element of the communication device 1100.

The disk 1106 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1107, on the hard disk 1104 or on a removable digital medium such as for example a disk 1106 as described previously. According to an optional variant, the executable code of the programs can be received by means of the communication network 1103, via the interface 1102, in order to be stored in one of the storage means of the communication device 1100, such as the hard disk 1104, before being executed.

The central processing unit 1111 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1104 or in the read only memory 1107, are transferred into the random-access memory 1112, which then contains the executable code of the program or programs, as well as registers for storing the variables and parameters necessary for implementing the invention.

In an embodiment, the apparatus is a programmable apparatus which uses software to implement the invention. However, alternatively, the present invention may be implemented in hardware (for example, in the form of an Application Specific Integrated Circuit or ASIC).

1. A method for processing data packets at an integrated access and backhaul, IAB, node of an IAB network comprising a plurality of IAB nodes, the method comprising:
receiving a data packet including a destination address of a destination IAB node for the data packet and a path identifier identifying a routing path for the data packet to the destination IAB node;
determining, based on the received data packet, whether the routing path of the received data packet includes at least one IAB node of a different IAB network;
in response to determining that the routing path of the received data packet includes at least one IAB node of a different IAB network, using the path identifier of the received data packet to determine whether there is a next IAB node in the routing path for routing the data packet,
when a next IAB node is determined, routing the data packet to the next IAB node.

2. The method of claim 1, wherein the destination address of the received data packet is not used to determine whether there is a next IAB node for routing the data packet.

3. The method of claim 1, further comprising receiving configuration information including a routing configuration table, each entry of the routing configuration table having a destination address field for an address of an IAB node and a path identifier field for a path identifier of a routing path to the IAB node,
wherein determining whether there is a next IAB node for routing the data packet using the path identifier of the received data packet comprises comparing the path identifier of the received data packet with the path identifier field of the routing configuration table,
when the path identifier of the received data packet matches a path identifier in the path identifier field, determining there is a next IAB node.

4. The method of claim 3, wherein when the path identifier of the received data packet does not match a path identifier in the path identifier field, determining there is not a next IAB node,
wherein the method further comprises comparing the destination address of the received data packet with an address assigned to the IAB node, and when the destination address of the received data packet matches the address assigned to the IAB node, determining the IAB node is the destination IAB node.

5. The method of claim 1, further comprising receiving configuration information including a routing configuration table, each entry of the routing configuration table having a destination address field for an address of an IAB node and a path identifier field for a path identifier of a routing path to the IAB node,
wherein determining whether there is a next IAB node for routing the data packet using the path identifier of the received data packet comprises comparing the path identifier of the received data packet with the path identifier field of the routing configuration table,
when the path identifier of the received data packet matches a path identifier in the path identifier field of an entry in the routing configuration table and when an address assigned to the IAB node does not match the address of the IAB node in the destination address field of the entry, determining there is a next IAB node.

6. The method of claim 5, wherein when the path identifier of the received data packet matches a path identifier in the path identifier field of an entry in the routing configuration table and when the destination address of the received data packet matches the address of the IAB node and the address in the destination address field of the entry, determining there is not a next IAB node and the IAB node is the destination IAB node.

7. The method of claim 1, wherein determining whether the routing path of the received data packet includes at least one IAB node of a different IAB network comprises determining, based on the path identifier of the received data packet, whether the routing path of the received data packet includes at least one IAB node of a different IAB network.

8. The method of claim 7, wherein one or more path identifier values of a plurality of path identifier values are assigned to represent one or more transit path identifiers, each one of the one or more path identifier values representing a respective transit path identifier identifying a transit path, wherein a transit path is a routing path including at least one IAB node of a different IAB network.

9. The method of claim 8, further comprising: receiving, from a donor Central Unit of the IAB network, routing configuration information indicating the one or more path identifier values assigned to the one or more transit path identifiers.

10. The method of claim 9, wherein the routing configuration information includes a transit configuration table, each entry in the transit configuration table including a transit path identifier field for one of the one or more path identifier values assigned to represent the one or more transit path identifiers.

11. The method of claim 10, wherein each entry of the transit table further includes a target IAB information field for indicating whether the destination IAB node for a data packet routed using the transit path identified by the transit path identifier in the transit path identifier field of the entry is in the IAB network of the IAB node or if the destination IAB node is part of a different IAB network.

12. The method of claim 8, wherein determining whether the routing path of the received data packet is a transit path comprises comparing the path identifier of the received data packet with the one or more path identifier values and when the path identifier matches one of the one or more path identifier values, determining that the routing path of the received data packet is a transit path.

13. The method of claim 3, wherein each entry of the routing configuration table further includes a transit path field for indicating whether the path identifier in the path identifier field is a transit path identifier identifying a transit path, wherein a transit path is a routing path including at least one IAB node of a different IAB network.

14. The method of claim 13, wherein determining whether the routing path of the received data packet is a transit path comprises comparing the path identifier of the received data packet with the path identifier field of the routing configuration table, and when the path identifier of the received packet matches a path identifier in the path identifier field of an entry with a value in the transit path field indicating the path identifier is a transit path identifier, determining that the routing path of the received data packet is a transit path.

15. The method of claim 1, wherein the data packet comprises a header including the path identifier and at least one bit configured to indicate whether the path identifier of the data packet is a transit path identifier identifying a transit path, wherein a transit path is a routing path including at least one IAB node of a different IAB network.

16. The method of claim 15, wherein the header includes a path identifier field for the path identifier of the data packet, wherein the at least one bit is at least one bit of the path identifier field or wherein the at least one bit is at least one reserved bit of the header.

17. The method of claim 1, wherein the IAB node is capable of routing data packets to one or more IAB nodes in the IAB network of the IAB node and to one or more IAB nodes in at least one different IAB network.

18. The method of claim 17, wherein the IAB node is assigned a first unique address for use by the IAB network of the IAB node and a second unique address for use by the at least one different IAB network.

19. The method of claim 17, further comprising sending a notification to a donor Central Unit, CU, of the IAB network, indicating the IAB node is capable of routing data packets to one or more IAB nodes in the at least one different IAB network.

20. A method for managing processing of data packets in a first integrated access and backhaul, IAB, network comprising a donor Central Unit, CU and a plurality of IAB nodes, each IAB node being assigned a unique address, the method at the donor CU comprising:
determining one or more transit paths corresponding to routing paths for routing data packets over the first IAB network and a second IAB network;
providing, to at least one IAB node of each transit path of the one or more transit paths, routing configuration information relating to the determined one or more transit paths corresponding to routing paths for routing data packets over at least the at least one IAB node of the first IAB network and at least one IAB node in the second IAB network, wherein the routing configuration information includes information for indicating one or more path identifier values assigned to represent one or more transit path identifiers, each one of the one or more path identifier values representing a respective transmit path identifier identifying a transit path.

21. The method of claim 20, further comprising:
receiving, from one IAB node of the plurality of IAB nodes, a notification indicating the IAB node is capable of routing data packets to one or more IAB nodes in the second IAB network;
sending, to a second donor CU of the second IAB network, an offload notification to establish the one or more transit paths, the notification including information relating to the one or more IAB nodes in the second IAB network;
receiving, from the second donor CU, information identifying one or more transit paths corresponding to routing paths for routing data packets over at least the IAB node of the first IAB network and at least one IAB node in the second IAB network,
wherein determining one or more transit paths corresponding to routing paths for routing data packets over the first IAB network and a second IAB network comprises determining one or more transit paths using the received information identifying one or more transit paths.

22. The method of claim 20, further comprising:
receiving, from one IAB node of the plurality of IAB nodes, a notification indicating the IAB node is capable of routing data packets to one or more IAB nodes in the second IAB network;
sending, to a second donor CU of the second IAB network, an offload notification to establish the one or more transit paths;
receiving, from the second donor CU, information relating to one or more possible transit paths corresponding to possible routing paths for routing data packets over at least the IAB node of the first IAB network and at least one IAB node in the second IAB network;
wherein determining one or more transit paths corresponding to routing paths for routing data packets over the first IAB network and a second IAB network comprises determining one or more transit paths using the received information relating to one or more possible transit paths, the method further comprising:
sending, to the second donor CU, information identifying the determined one or more transit paths corresponding to routing paths for routing data packets over at least the IAB node of the first IAB network and at least one IAB node in the second IAB network.

23. The method of claim 21, wherein the offload notification further includes information identifying routing paths currently in use for data packets over the first IAB network and/or information identifying possible one or more transit paths.

24. The method of claim 20, wherein one or more path identifier values of a plurality of path identifier values are assigned to represent one or more transit path identifiers, each one of the one or more path identifier values representing a respective transit path identifier identifying a transit path,
wherein the routing configuration information includes:
a routing configuration table, each entry of the routing configuration table having a destination address field for an address of an IAB node and a path identifier field for a path identifier of a routing path to the IAB node;
path identifier information indicating the one or more path identifier values assigned to the one or more transit path identifiers.

25. The method of claim 24, wherein the path identifier information includes a transit configuration table, each entry in the transit configuration table including a transit path identifier field for one of the one or more path identifier values assigned to represent the one or more transit path identifiers.

26. The method of claim 25, wherein each entry of the transit table further includes a target IAB information field for indicating whether the destination IAB node for a data packet routed using the transit path identified by the transit path identifier in the transit path identifier field of the entry is in the IAB network of the IAB node or if the destination IAB node is part of a different IAB network.

27. The method of claim 20, wherein the routing configuration information includes:
a routing configuration table, each entry of the routing configuration table having a destination address field for an address of an IAB node, a path identifier field for a path identifier of a routing path to the IAB node and a transit path field for indicating whether the path identifier in the path identifier field is a transit path identifier identifying a transit path.

28. The method of claim 24, wherein each entry of the routing configuration table further includes a next-hop address field for the unique address of a node in the IAB network that is a next node in the routing path.

29. Apparatus for an Integrated access and backhaul, IAB, node for an IAB network comprising a plurality of IAB nodes, the apparatus comprising:
at least one processor configured to:
receive a data packet including a destination address of a destination IAB node for the data packet and a path identifier identifying a routing path for the data packet to the destination IAB node;
determine, based on the received data packet, whether the routing path of the received data packet includes at least one IAB node of a different IAB network;
in response to determining that the routing path of the received data packet includes at least one IAB node of a different IAB network, use the path identifier of the received data packet to determine whether there is a next IAB node in the routing path for routing the data packet,
when a next IAB node is determined, route the data packet to the next IAB node.

30. An apparatus for a donor Central Unit, CU, for managing processing of data packets in an integrated access and backhaul, IAB, network comprising a plurality of IAB nodes, the apparatus comprising:
at least one processor configured to:
determine one or more transit paths corresponding to routing paths for routing data packets over the first IAB network and a second IAB network;
provide, to at least one IAB node of each transit path of the one or more transit paths, routing configuration information relating to the determined one or more transit paths corresponding to routing paths for routing data packets over at least the at least one IAB node of the first IAB network and at least one IAB node in the second IAB network, wherein the routing configuration information includes information for indicating one or more path identifier values assigned to represent one or more transit path identifiers, each one of the one or more path identifier values representing a respective transmit path identifier identifying a transit path.

31. (canceled)

32. A computer-readable storage medium storing instructions which, when the program is executed by at least one processor of an integrated access and backhaul, IAB, node of an IAB network comprising a plurality of IAB nodes, cause the at least one processor to:
receive a data packet including a destination address of a destination IAB node for the data packet and a path identifier identifying a routing path for the data packet to the destination IAB node;
determine, based on the received data packet, whether the routing path of the received data packet includes at least one IAB node of a different IAB network;
in response to determining that the routing path of the received data packet includes at least one IAB node of a different IAB network, use the path identifier of the received data packet to determine whether there is a next IAB node in the routing path for routing the data packet,
when a next IAB node is determined, route the data packet to the next IAB node.
